(19) United States
(12) Patent Application Publication
(10) Pub. No.: US 2006/0026060 A1
(43) Pub. Date: Feb. 2, 2006

(54) System and method for provision of advertiser services including client application

(76) Inventor: Robert J. Collins, Carlsbad, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 11/026,496

(22) Filed: Dec. 30, 2004

Related U.S. Application Data
(60) Provisional application No. 60/592,799, filed on Jul. 30, 2004.

(51) Int. Cl. G06Q 30/00

(52) U.S. Cl. 705/14

(57) ABSTRACT

The present invention provides systems and methods for provision of advertiser services including a client application or applications. Methods are provided that include one or more servers providing one or more user-interactive applications to allow advertisers access to and manipulation information relating to ad campaigns, in order to facilitate managing the ad campaigns. Computerized methods and systems are provided that facilitate or automate management or optimization of advertising campaigns, including advertising campaigns or campaign components that use sponsored search result listings.

### PRIORITY APPLICATIONS

This application claims priority to U.S. Provisional Patent Application No. 60/592,799, filed on Jul. 30, 2004, entitled, “METHODS AND SYSTEMS FOR USE IN A COMPUTERIZED SEARCH-BASED ADVERTISING MARKET”, U.S. Patent Application No. 60/546,699 filed on Feb. 20, 2004, entitled, “COMPUTERIZED ADVERTISING OFFER EXCHANGE”, and U.S. patent application Ser. No. 10/783,383 also filed on Feb. 20, 2004, entitled, “COMPUTERIZED ADVERTISING OFFER EXCHANGE”.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates in general to advertising, and in particular to advertising campaign management and optimization systems, methods, and apparatuses.

The success of advertising campaigns depends on making the most efficient possible use of an advertising budget to advertise so as to maximally influence audience behavior. For example, if a campaign is directed to selling a product, then the advertiser may seek to use a given budget to purchase advertising so as to cause a maximum amount of consumers to purchase the product. Determining how to efficiently and optimally spend an advertising budget, as well as implementing and managing an ongoing advertising campaign (or campaigns) utilizing such a budget, however, can pose a daunting challenge to advertisers.

Increasingly, advertising campaigns include online or Internet-based advertising. With ever-increasing Internet use, it is only natural that greater advertising resources are directed to this rich audience. Furthermore, Internet-based advertising allows great opportunities for advertisers to deliver much more targeted, relevant ads than conventional, off-line advertising techniques, such as billboards and the like.

An increasingly important area of advertising includes sponsored listings. Such listing can be presented, for example, in the form of sponsored links appearing among the results of a search conducted on an Internet-based search engine, such as Yahoo!, Ask Jeeves, etc. For instance, auction-based systems exist in which advertisers bid on-line to be included among the sponsored search results for a particular search term or terms, and for the ranking or prominence of the placement of their sponsored listing among such results.

Online advertisers participating in such an auction-based system may face the challenge of managing and optimizing potentially frequent bidding on, for example, each of thousands or hundreds of thousands of search terms or groups of search terms. Moreover, an advertiser may need to manage and optimize numerous advertising campaigns across numerous disparate portals. Furthermore, an advertiser may need to manage and optimize off-line components of an advertising campaign or campaigns. All this, while the advertiser's skills and energies are needed and may be better suited for many other different business tasks.

Existing techniques for managing and optimizing advertising campaigns fall far short of providing efficient, effective solutions to these problems.

There is a need in the art for systems and methods for managing and optimizing advertising campaigns.

### SUMMARY OF THE INVENTION

In some embodiments, the present invention provides systems, methods, and apparatuses for facilitating managing and optimizing advertising campaigns. Computerized methods, systems, and apparatuses are provided that facilitate or automate management or optimization of advertising campaigns, including advertising campaigns or campaign components that use sponsored search result listings. In some embodiments, information relating to advertising campaigns and advertising campaign performance is collected from disparate sources, integrated, and utilized to facilitate determination of optimal ad (advertising) campaign strategies as well as to facilitate management of ad campaigns and implementation of ad campaign strategies.

In one embodiment, the invention provides a method for facilitating managing ad campaigns. The method includes one or more ad campaigns facilitation servers, of an ad campaigns facilitator, obtaining ad campaign information, relating to the ad campaigns, from one or more advertisers. The method further includes the one or more ad campaigns facilitation servers obtaining ad campaign performance information, relating to the ad campaigns, from the one or more advertisers and from each of a plurality of affiliates of the ad campaign facilitator. The method further includes the one or more ad campaigns facilitation servers storing the ad campaign information and the ad campaign performance information in one or more ad campaigns databases. The method further includes the one or more ad campaigns facilitation servers facilitating managing ad campaigns utilizing at least a portion of the ad campaign information and at least a portion of the ad campaign performance information.

In another embodiment, the invention provides a system for facilitating managing ad campaigns. The system includes a computer network; one or more ad campaigns facilitation servers, of an ad campaign facilitator, connected to the network; one or more ad campaigns databases connected to the one or more ad campaigns facilitation servers; a plurality of affiliates, of the ad campaign facilitator, connected to the network; and a plurality of advertisers connected to the network. The one or more ad campaigns facilitation servers are adapted to obtain ad campaign information, relating to the ad campaigns, from the advertisers; to obtain ad campaign performance information, relating to the ad campaigns, from the advertisers and the affiliates; to store the ad campaign information and the ad campaign performance information in one or more ad campaigns databases; and to facilitate managing of ad campaigns utilizing at least a portion of the ad campaign information and at least a portion of the ad campaign performance information.

In another embodiment, the invention provides a method for integrating ad campaign performance information from a plurality of disparate sources. The method includes one or more ad campaigns facilitation servers, of an ad campaigns facilitator, obtaining ad campaign information, relating to the ad campaigns, from one or more advertisers. The method further includes the one or more ad campaigns facilitation servers obtaining ad campaign performance information, relating to the ad campaigns, from the advertisers and from each of a plurality of disparate affiliates of the ad campaign facilitator. The method further includes the one or more ad campaigns facilitation servers storing the ad campaign information and the ad campaign performance information in one or more ad campaigns databases in an integrated manner.

In another embodiment, the invention provides a method for integrating ad campaign information from a plurality of disparate sources. The method includes one or more ad campaigns facilitation servers, of an ad campaigns facilitator, obtaining ad campaign information, relating to the ad campaigns, from one or more disparate advertisers. The method further includes the one or more ad campaigns facilitation servers obtaining ad campaign performance information, relating to the ad campaigns, from the advertisers and from each of a plurality of affiliates of the ad campaign facilitator. The method further includes the one or more ad campaigns facilitation servers storing the ad campaign information and the ad campaign performance information in one or more ad campaigns databases in an integrated manner.

In other embodiments, the invention provides an apparatus or system for providing an interactive advertiser interface to facilitate managing one or more ad campaigns. The apparatus or system includes one or more ad campaigns facilitation servers, of an ad campaign facilitator, connected to a network; one or more ad campaigns databases connected to the one or more ad campaigns facilitation servers; a plurality of affiliates, of the ad campaign facilitator, connected to the network; and a plurality of advertisers connected to the network. The one or more ad campaigns facilitation servers are adapted to obtain ad campaign information, relating to the ad campaigns, from one or more advertisers; to obtain ad campaign performance information, relating to the ad campaigns, from the advertisers and the affiliates; to store the ad campaign information and the ad campaign performance information in the one or more ad campaigns databases; and to provide one or more user-interactive applications to allow advertisers access to and manipulation of ad campaign and ad campaign performance information, in order to facilitate managing the ad campaigns.

In another embodiment, the invention provides a method for facilitating automatically managing ad campaigns in an auction-based search term-related sponsored listings marketplace. The method includes one or more ad campaigns facilitation servers, of an operator of the marketplace, obtaining ad campaign information, relating to the ad campaigns, from one or more advertisers. The method further includes the one or more ad campaigns facilitation servers obtaining ad campaign performance information, relating to the ad campaigns, from the one or more advertisers and from each of a plurality of disparate affiliates of the ad campaign facilitator, the ad campaign performance information including information based on which return per lead metrics can be determined. The method further includes the one or more ad campaigns facilitation servers storing the ad campaign information and the ad campaign performance information in one or more ad campaigns databases in an integrated manner. The method further includes the one or more ad campaigns facilitation servers facilitating automatically managing ad campaigns utilizing at least a portion of the ad campaign information, at least a portion of the ad campaign performance information. The one or more ad campaigns facilitation servers facilitating automatically managing ad campaigns includes facilitating automatically implementing bidding strategies for advertisers in the marketplace, and includes providing a user-interactive interface to allow the one or more advertisers to access and modify at least a portion of information stored in the ad campaigns database.

In another embodiment, the invention provides a computer usable media storing program code which, when executed on computerized devices, causes the computerized devices to execute a method for facilitating managing ad campaigns. The method includes one or more ad campaigns facilitation servers, of an ad campaigns facilitator, obtaining ad campaign information, relating to the ad campaigns, from one or more advertisers. The method further includes the one or more ad campaigns facilitation servers obtaining ad campaign performance information, relating to the ad campaigns, from the one or more advertisers and from each of a plurality of affiliates of the ad campaign facilitator. The method further includes the one or more ad campaigns facilitation servers storing the ad campaign information and the ad campaign performance information in one or more ad campaigns databases. The method further includes the one or more ad campaigns facilitation servers facilitating managing ad campaigns utilizing at least a portion of the ad campaign information and at least a portion of the ad campaign performance information.

In another embodiment, the invention provides a method for facilitating optimizing ad campaigns. The method includes one or more ad campaigns facilitation servers, of an ad campaigns facilitator, obtaining ad campaign information, relating to the ad campaigns, from one or more advertisers. The method further includes the one or more ad campaigns facilitation servers obtaining ad campaign performance information, relating to the ad campaigns, from the one or more advertisers and from each of a plurality of affiliates of the ad campaign facilitator. The method further includes the one or more ad campaigns facilitation servers storing the ad campaign information and the ad campaign performance information in one or more ad campaigns databases. The method further includes, using the one or more ad campaigns facilitation servers, and based at least in part on at least a portion of the ad campaign information and at least a portion of the ad campaign performance information, determining an optimal ad campaign strategy for at least a first ad campaign of the ad campaigns.

In another embodiment, the invention provides a method for facilitating optimizing ad campaigns based at least in part on a return per lead metric. The method includes one or more ad campaigns facilitation servers, of an ad campaigns facilitator, obtaining ad campaign information, relating to the ad campaigns, from one or more advertisers. The method further includes the one or more ad campaigns facilitation servers obtaining ad campaign performance information, relating to the ad campaigns, from the one or more advertisers and from each of a plurality of affiliates of the ad campaign facilitator. The method further includes the one or more ad campaigns facilitation servers storing the ad campaign information and the ad campaign performance information in one or more ad campaigns databases. The method further includes, using the one or more ad campaigns facilitation servers, and based at least in part on at least a portion of the ad campaign information and at least a portion of the ad campaign performance information, calculating one or more ROAS metrics. The method further includes, based at least in part on the calculated one or more ROAS metrics, determining an optimal ad campaign strategy for at least a first ad campaign of the ad campaigns.

In another embodiment, the invention provides a method for managing a flow of targeted leads from an affiliate of an ad campaign facilitator to an advertiser Web site. The method includes one or more ad campaigns facilitation servers facilitating presentation of a targeted on-line ad to a user of a Web site of the affiliate, the on-line ad including a link adapted to enable the user to visit the advertiser's Web site. The method further includes the one or more ad campaigns facilitation servers obtaining from the affiliate, and storing in an ad campaigns database, ad campaign performance information relating to performance of the on-line ad. The method further includes, if the user utilizes the on-line ad to visit the advertiser's Web site, redirecting the visitor to a Web site associated with the one or more ad campaigns facilitation servers to collect ad campaign performance information before directing the user to the Web site of the advertiser.

In another embodiment, the invention provides a system for facilitating optimizing ad campaigns. The system includes a network; one or more ad campaigns facilitation servers, of an ad campaigns facilitator, connected to the network; one or more ad campaigns databases accessible by the one or more ad campaigns facilitation servers; a plurality of affiliates of the ad campaigns facilitator, connected to the network; and a plurality of advertisers connected to the network. The one or more ad campaigns facilitation servers are adapted to obtain ad campaign information, relating to the ad campaigns, from the advertisers; to obtain ad campaign performance information, relating to the ad campaigns, from the advertisers and the affiliates; to store the ad campaign information and the ad campaign performance information in one or more ad campaigns databases; and to determine, based at least in part on at least a portion of the ad campaign information and at least a portion of the ad campaign performance information, an optimal ad campaign strategy for at least a first ad campaign of the ad campaigns.

In another embodiment, the invention provides a computer usable media storing program code which, when executed on computerized devices, causes the computerized devices to execute a method for facilitating optimizing ad campaigns. The method includes one or more ad campaigns facilitation servers, of an ad campaigns facilitator, obtaining ad campaign information, relating to the ad campaigns, from one or more advertisers. The method further includes the one or more ad campaigns facilitation servers obtaining ad campaign performance information, relating to the ad campaigns, from the one or more advertisers and from each of a plurality of affiliates of the ad campaign facilitator. The method further includes the one or more ad campaigns facilitation servers storing the ad campaign information and the ad campaign performance information in one or more ad campaigns databases. The method further includes, using the one or more ad campaigns facilitation servers, and based at least in part on at least a portion of the ad campaign information and at least a portion of the ad campaign performance information, determining an optimal ad campaign strategy for at least a first ad campaign of the ad campaigns.

In another embodiment, the invention provides a method for facilitating automatically optimizing ad campaigns in an auction-based search term-related sponsored listings marketplace. The method includes one or more ad campaigns facilitation servers, of an operator of the marketplace, obtaining ad campaign information, relating to the ad campaigns, from one or more advertisers. The method further comprises the one or more ad campaigns facilitation servers obtaining ad campaign performance information, relating to the ad campaigns, from the one or more advertisers and from each of a plurality of disparate affiliates of the ad campaign facilitator, the ad campaign performance information including information based on which one or more return per lead metrics can be determined. The method further includes the one or more ad campaigns facilitation servers storing the ad campaign information and the ad campaign performance information in one or more ad campaigns databases in an integrated manner. The method further includes, using the one or more ad campaigns facilitation servers, and based at least in part on at least a portion of the ad campaign information and at least a portion of the ad campaign performance information, automatically determining an optimal ad campaign strategy for at least a first ad campaign of the ad campaigns. Automatically determining an optimal ad campaign strategy comprises automatically determining a recommended course of action, for a future period of time, for one or more settings of one or more parameters of the ad campaign strategy to be utilized for the future period of time.

In another embodiment, the invention provides computer usable media storing program code which, when executed on computerized devices, causes the computerized devices to execute a method for facilitating automatically optimizing ad campaigns in an auction-based search term-related sponsored listings marketplace. The method includes one or more ad campaigns facilitation servers, of an operator of the marketplace, obtaining ad campaign information, relating to the ad campaigns, from one or more advertisers. The method further comprises the one or more ad campaigns facilitation servers obtaining ad campaign performance information, relating to the ad campaigns, from the one or more advertisers and from each of a plurality of disparate affiliates of the ad campaign facilitator, the ad campaign performance information including information based on which one or more return per lead metrics can be determined. The method further includes the one or more ad campaigns facilitation servers storing the ad campaign information and the ad campaign performance information in one or more ad campaigns databases in an integrated manner. The method further includes, using the one or more ad campaigns facilitation servers, and based at least in part on at least a portion of the ad campaign information and at least a portion of the ad campaign performance information, automatically determining an optimal ad campaign strategy for at least a first ad campaign of the ad campaigns. Automatically determining an optimal ad campaign strategy comprises automatically determining a recommended course of action, for a future period of time, for one or more settings of one or more parameters of the ad campaign strategy to be utilized for the future period of time.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram depicting a distributed system according to an embodiment of the invention;

FIG. 2 is a flow diagram depicting a method according to one embodiment of the invention;

FIG. 3 is a block diagram of a networked computer system according to one embodiment of the invention;

FIG. 4 is a block diagram depicting tag-based automated data tracking and collecting according to one embodiment of the invention;

FIG. 5 is a block diagram depicting components of an ad campaigns facilitation program, according to one embodiment of the invention;

FIG. 6 is a block diagram of a system according to one embodiment of the invention;

FIG. 7 is a flow diagram depicted a method according to one embodiment of the invention;

FIG. 8 is a graph of conversion rate versus time for a hypothetical search term or term group, according to one embodiment of the invention;

FIG. 9 is a graph of hypothetical buy cycles, according to one embodiment of the invention; and

FIG. 10 is a simplified screen shot according to one embodiment of the invention.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

Herein, the term “advertiser ad campaign set” includes a set of one or more advertising campaigns of a particular advertiser or advertising entity. The term “ad campaign” includes a set of one or more advertising activities or conduct directed to accomplishing a common advertising goal, such as the marketing or sales of a particular product, service, or content, or a group of products, services or content. Two ad campaigns are considered disparate from each other if each of the ad campaigns is directed to a different advertising goal.

The term “tactic” includes a particular form or type of advertising. For example, in on-line advertising, tactics can include sponsored search result listings, banner advertisements, etc. In off-line advertising, tactics can include television commercials, radio commercials, newspaper advertisements, etc. In different embodiments, tactics can be more or less broadly defined to include subsets or supersets of the listed examples or other examples. For instance, on-line advertising is an example of a broader tactic than the narrower tactic of sponsored search result listings.

The term “channel” includes a particular entity, organization, or the like, through which advertising may be conducted. In the on-line advertising context, for example, channels can include Web sites or search engines such as MSN, CNN, Yahoo!, etc. Herein, the term “computer” includes, for example, a desktop computer, notebook computer, or computerized device such as, for example, a handheld computerized device or cell phone.

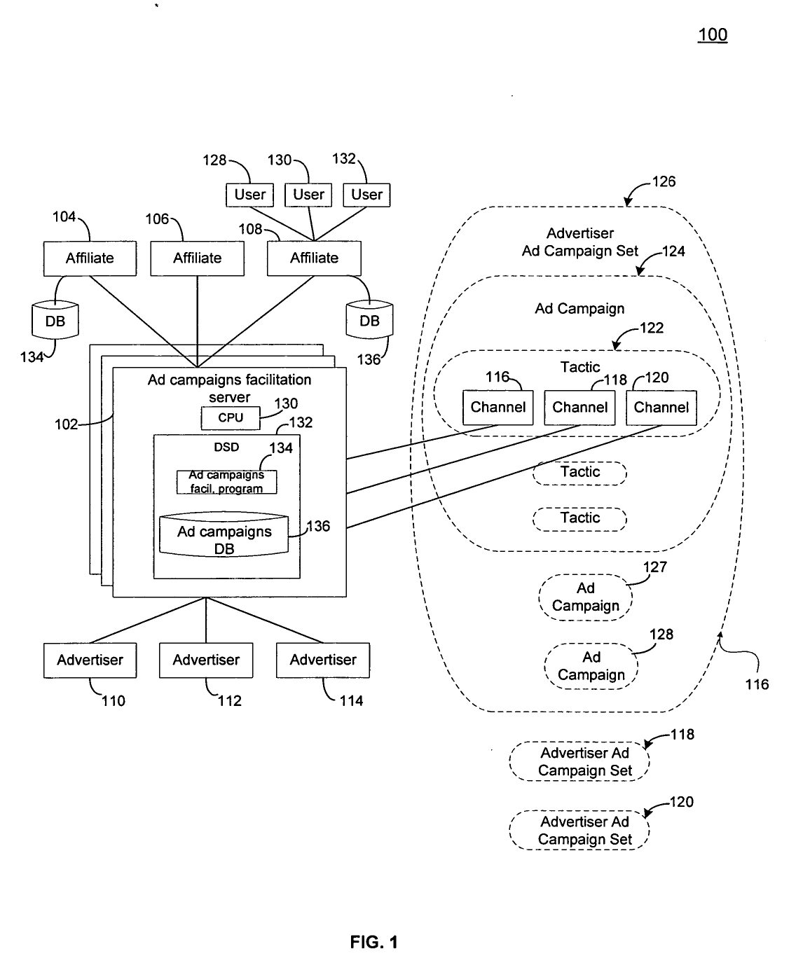

Herein, any two affiliates, advertisers, or sources of information such as ad campaign or ad campaign performance information, are considered disparate from each other if the affiliates, advertisers, or other sources utilize different platforms, programs, applications, hardware, software, or data storage techniques with respect to information collection, storage, or communication such that the ad campaigns facilitation server 102 (as depicted in FIG. 1) must employ a different technique or set of techniques, with respect to programming or applications, to receive, recognize, parse, or store the information from each of the two affiliates, advertisers, or other sources.

Herein, the term “search term creative” includes, in an auction-based search term-related sponsored listings marketplace, a search term-related subject of bidding, such as a search term, set or group of search terms. A creative includes any rules specifying conditions in connection with the search term or group that will cause entitlement to display of an ad or sponsored listing.

Some embodiments of the invention can be used with features or technologies described in U.S. patent application Ser. No. 10/072,220, filed on Feb. 8, 2002, entitled, “AUTOMATIC FLIGHT MANAGEMENT IN AN ONLINE MARKETPLACE”, which application is hereby incorporated herein by reference in its entirety.

FIG. 1 is a block diagram depicting a distributed system 100 according to an embodiment of the invention. The system 100 includes the ad campaigns facilitation server computer(s) 102 (which can, in some embodiments, include multiple server computers), multiple affiliates 104, 106, 108, multiple advertisers 110, 112, 114, multiple users 128, 130, 132 and multiple channels 116, 118, 120. The depicted channels 116, 118, 120 are part of a conceptually represented tactic 122, which tactic 122 is part of a conceptually represented ad campaign 124, which ad campaign 124 is part of a conceptually represented advertiser ad campaign set 126. The advertiser ad campaign set 126 includes other ad campaigns 127, 128, which can include other tactics (not shown) and channels (not shown). Other advertiser campaign sets 118, 120 are also depicted, which can themselves include ad campaigns (not shown), tactics (not shown) and channels (not shown).

The ad campaigns facilitation server computer(s) 102 (hereinafter, “Server 102”) includes a central processing unit (CPU) 130 and a data storage device 132. Furthermore, each of the affiliates 104, 106, 108 and advertisers 110, 112, 114, and some or all of the users 128, 130, 132 include at least one computer having a central processing unit (not shown) and a data storage device (not shown), which may include one or more browser programs, such as Internet browser programs.

Some or all of the affiliates 104, 106, 108 may include or be connected with a database. As depicted, the affiliates 104 and 108 are connected with databases 134 and 136, respectively.

While no network is depicted, some or all of the computers may be connected by one or more computer networks, such as the Internet as well as one or more wide area networks, local area networks, personal area networks, etc.

While all of the users 128, 130, 132 are depicted as being connected to the affiliate 108, it is to be noted that some or all of the users 128, 130, 132 can be not electronically connected, such as a user who is, for example, a reader of an affiliate's magazine.

While only three each of users, affiliates, advertisers, tactics, channels, ad campaigns, and ad campaign sets are shown for simplicity, it is to be understood that fewer, or many more, may be present.

Each of the data storage devices may comprise various amounts of RAM for storing computer programs and other data. In addition, each of the computers may include other components typically found in computers, including one or more output devices such as monitors, other fixed or removable data storage devices such as hard disks, floppy disk drives and CD-ROM drives, and one or more input devices, such as mouse pointing devices and keyboards.

Generally, each of the computers operate under and execute computer programs under the control of an operating system, such as Windows, Macintosh, UNIX, etc.

Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

The data storage device 134 of the Server(s) 102 includes an ad campaigns facilitation program 134 and an ad campaigns database 136. The ad campaigns facilitation program 134 broadly represents all programming, software, tools, applications, application program interfaces (API), or other tools used in carrying out methods according to embodiments of the invention, including methods associated with management or optimization of ad campaigns. Although the ad campaigns facilitation program 134 is depicted as being located at the Server 102, in some embodiments, elements or components of the ad campaigns facilitation program 134 may be located elsewhere, such as at computers associated with affiliates, advertisers, or channels in order to facilitate communication between the Server 102 and other entities or computers.

In some embodiments, the Server 102 is owned, controlled, or operated by an ad campaign facilitator, such as an entity or company that facilitates planning, management, optimization, delivery, communication, or implementation of advertisements (ads) or ad campaigns. In some embodiments, advertising campaigns may include sponsored search results listings or links. An auction-based system or marketplace may be used by advertisers to bid for search terms or groups of terms which, when used in a search, will cause display of their advertisement listings or links among the display results. Advertisers may bid for position or prominence of their listings in search results, as well. In such embodiments, the campaign facilitator is or includes a marketplace operator that may, for example and among other things, control operate, or manage the auction-based system.

While the Server 102 may be used in facilitating arrangements relating to presentation of advertisements, it is to be noted that in some embodiments, the Server 102 (and the associated ad campaigns facilitator) does not arrange or assist in arranging presentation of advertisements. For example, in some embodiments, the Server 102 may be used in facilitating management or optimization of ad campaigns, or automatically facilitating the management or optimization of ad campaigns, without actually itself arranging for presentation of advertisements.

More detail regarding and aspects of auction-based systems, and the marketplace operator, as mentioned above, can be found in commonly owned U.S. Patent application Ser. No. 10/625,082 filed on Jul. 22, 2003, entitled, “TERM-BASED CONCEPT MARKET”, U.S. patent application Ser. No. 10/625,000, entitled, “CONCEPT VALUATION IN A TERM-BASED CONCEPT MARKET filed on Jul. 22, 2003, and U.S. patent application Ser. No. 10/625,001 filed on Jul. 22, 2003, entitled, TERM-BASED CONCEPT INSTRUMENTS”, all of which applications are hereby incorporated herein by reference in their entirety. In some embodiments, systems and methods associated with ad campaign management and optimization according to the present invention can be practiced in combination with methods and systems described in these listed incorporated by reference applications.

Each of the advertiser ad campaign sets 126, 118, 120 represents a set of one or more ad campaigns of a particular advertiser, such as one of the depicted advertisers 110, 112, 114. The affiliates 104, 106, 108 represent entities, organizations, or companies, in any way associated or affiliated with the ad campaign facilitator or the Server 102. Affiliates can include entities that are associated with the ad campaigns facilitator or the Server 102 only in that arrangements of some sort are made to facilitate communication of ad campaign performance information to the Server 102; no further affiliation or association beyond this need exist for an entity to be considered an affiliate.

Through the affiliates (or their outlets, portals, media, companies, etc.) advertisements may be presented. Off-line affiliates include entities through or in connection with which various kinds of off-line ads may be presented, such as television stations, radio stations, newspapers or newspaper organizations, magazines or magazine organizations, etc. On-line affiliate include entities through or in connection with which Internet-based or Internet-accessible advertisements may be presented, such as search engines like Yahoo!, Ask Jeeves, etc., e-commerce sites, or other Web sites such as news or content providing Web sites, sports Web sites, etc.

Affiliates may be disparate from each other. For example, the Server 102 may need to employ different programming or applications in order to process, re-format or translate ad campaign performance information received from disparate affiliates and store the information in the ad campaigns database 136.

Affiliates may be different in terms of in terms of the type of ad presentation or ad presentation medium they control. Furthermore, they may be different with respect to the manner or platform in which they format, store and send information, including hardware, software, programming, databases, or applications utilized for these purposes. They may also be different in terms of any data or combinations of data they collect and store regarding ads, ad or ad campaign performance, audiences of the ads such as users of an affiliate's Web site or search engine, etc.

Advertisers include entities, individuals, companies, organizations, etc. that arrange, such as with the ad campaign facilitator, for advertisements to be presented through affiliates, such as an ad in an affiliate's newspaper or a sponsored listing appearing in a set of search results obtained via an affiliate's search engine or Web site. In some embodiments, advertisers, as well, or some of them, may be disparate from each other.

Users, such as the depicted users 128, 130, 132, are users of, or audiences exposed to, resources, media, outlets, etc. associated with affiliates, to whom advertisements are presented through affiliates. For example, users include readers of an affiliate's newspaper or computer users who use an affiliate's search engine or browse an affiliate's Web site.

The Server 102 facilitates management or optimization of ad campaigns or ad campaign sets for advertisers, or automatic management or optimization of ad camapaigns, and may facilitate arranging for presentation of advertisements through affiliates. The Server can also be used to facilitate storage, organization, and management of information sent to the Server 102 by entities including affiliates and advertisers.

While the depicted affiliates 104, 106, 108 may be of off-line type (such as newspapers), or on-line type (such as Web sites), each of the depicted affiliates 104, 106, 108 includes at least one computer that is capable of communicating with the Server 102, although in some embodiments one or more of the affiliates may not be electronically connected to the Server 102 and may send information non-electronically to ultimately be stored electronically in the Server 102. Each of the affiliates 104, 106, 108 can transmit to or communicate information to the Server 102. It is to be noted that, while the ad campaigns facilitation program 134 is depicted at the Server 102, it can include components, such as programming, located elsewhere, including programming, software, or applications located at or executed by computers of affiliates, such as for example, HTML tag-related programming, as further described below.

Data sent from computers of affiliates to the Server 102 can be obtained by the Servers and stored in the ad campaigns database 136 in an integrated manner, meaning that all of the data is stored together as a whole and such that the meaning of the data, including any and all subsets of the data, regardless of source or sources, can be recognized. The ad campaigns facilitation program 134 may be used to parse, re-format, analyze, or otherwise process data sent from the affiliates, using methods known by those skilled in the art, as necessary for the purpose of integration. Communications between affiliates and the Server 102 may be facilitated by shared or complimentary programming, applications, or interfaces between affiliates and the Server 102. In some embodiments, for example, affiliate's computers make use of application program interfaces (APIs) in communicating with the server computer 102 or programs or applications thereof.

In some embodiments, affiliates, such as affiliates 104, 108, store data including in their associated databases 134, 136 which can include, among other information, ad campaign performance information and user information.

Ad campaign performance information can include a variety of information, statistics, or metrics indicating or suggesting performance or success of an ad, a channel (or an ad or ads presented through a channel, etc.), a tactic, a campaign, multiple campaigns, component or aspect of a campaign, etc. For example, ad campaign performance information can include information regarding how frequently a sponsored listing results on an affiliate's Web site gets presented, or clicked on, or results in user visits to a linked Web page, user purchases at a linked Web site, etc.

For instance, ad campaign performance information can include one or more metrics that provide an indication of value per lead. For example, such metrics can provide an indication of how many or what proportion of clicks on a sponsored link actually result in return of any sort to the advertiser. Such return can depend on the particular advertiser and the advertiser's business objectives. If the advertiser is attempting to sell products, services, or content, for example, return can include purchases at the advertiser's Web site resulting from or attributable to leads. Return is not limited to sales, however. Return can be anything of value to the advertiser which is gained from the conduct or action of a lead-attributable visitor to the advertiser's Web site. Accordingly, the term “return per lead”, as used herein, includes any type of return resulting from or attributable to leads. Furthermore, “return per lead metric”, as used herein, includes any metric providing a measure, indication, or suggestion of return per lead.

Particular advertisers may have different business objectives, and may specify their business objectives in different ways. For instance, some advertisers may specify business objectives using a CPA (cost per acquisition) target. For such advertisers, a conversion rate may be an appropriate return per lead metric. Furthermore, some advertisers may specify business objectives in terms of ROAS (return on advertising spend). For such advertisers, revenue per lead may be an appropriate return per lead metric. Some advertisers may specify business objectives using a blend or combination of metrics or measures, for which a blend or combination of return per lead metrics may be appropriate.

Some embodiments of the invention are described herein specifically with reference to conversion rates. It is to be understood, however, that this is exemplary, and conversion rate is just one of many possible return per lead metrics. Accordingly, embodiments of the invention described with reference to conversion rates are not limited to the use of conversion rate related metrics, and can use or incorporate other or additional return per lead metrics. Furthermore, some embodiments of the invention are described herein specifically with reference to business objectives expressed in terms of ROAS. It is to be understood that this also is exemplary, and other or additional gauges or measures of business objectives may be used in different instances.

In some embodiments, the invention provides methods for facilitating automatic management or optimization of one or more ad campaigns. This can include utilizing business rules that may be specific to or specified by a particular advertiser as well as using business results or measures thereof, which can include ad campaign performance information or measures of aspects thereof. In some embodiments, the invention includes combining business rules with an aggregated real-time business result, or measure thereof, to facilitate automated, dynamic, real-time management or optimization of ad spending.

Advertiser business rules may be explicitly defined or may be implicitly defined, inferred, deduced, or obtained, for example, using the ad campaigns facilitation program 134 and utilizing ad campaign performance information, which may include ad result metrics, for example. Furthermore, in some embodiments, business rules may be modified automatically, or modifications may be recommended automatically for advertiser review and approval before implementation. In some embodiments, ad campaign performance information is analyzed automatically by the ad campaigns facilitation program 134 and, based on the analysis, business rules may be obtained, modified, or optimized for maximum advertiser benefit.

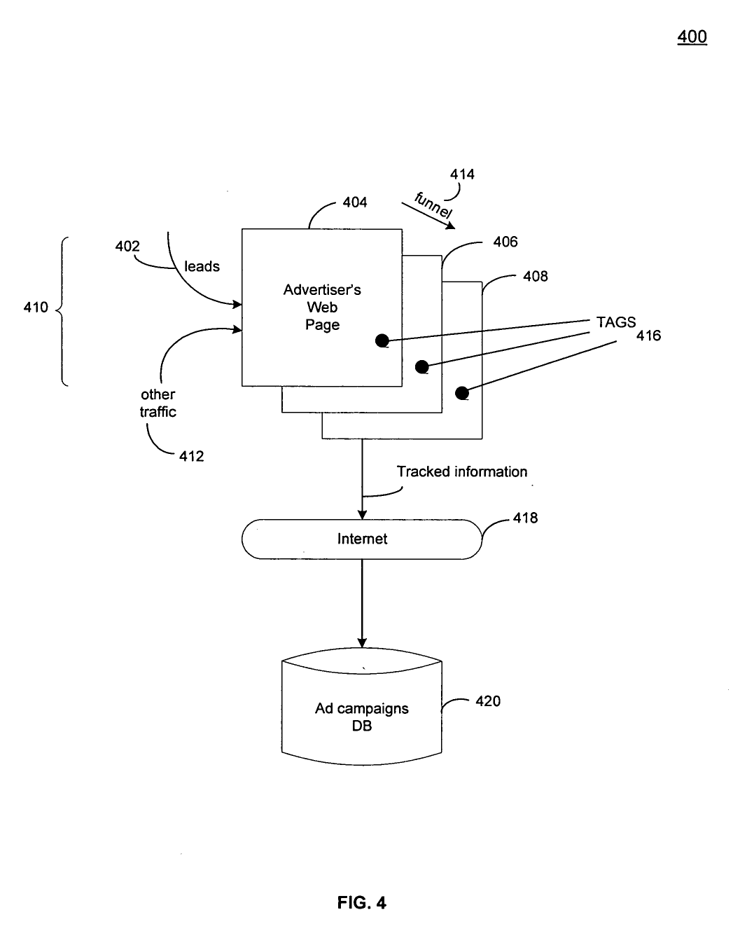

Tracking and collection of ad performance information can be accomplished using, for example, HTML tagging of advertiser Web sties, as described further below with reference to FIG. 4. Ad campaign performance information can be obtained from affiliates as well as advertisers. For instance, in some embodiments, the ad campaigns

User information can include information obtained and stored by affiliates (or channels) including user profiles, historical user behavior information, etc., or can be sent from affiliates or other entities to the Server 102 and stored in the ad campaigns database 136. Additional description of user information and its uses can be found in previously incorporated by reference U.S. patent Application Nos. 60/546,699 and 10/783,383.

Data obtained and stored by affiliates and advertisers, or a portion of it, is transmitted to the Server 102, translated or reformatted, if necessary into format useable and storable in the ad campaigns database 136, and stored therein. Alternatively, the data may be translated or re-formatted prior to being transmitted, or otherwise manipulated to allow appropriate storage in the ad campaigns database 136. Some affiliates or advertisers may transmit user profile, user behavior or user history data directly to the Server 102 without non-volatile storage in a database associated with the affiliate, or may even send data in a non-electronic format, for example, the ad campaign facilitator, after which the data may be converted to electronic format and stored in the Server 102.

Each of the advertiser ad campaign sets 126, 118, 120 is associated with one of the advertisers 110, 112, 114. For example, an advertiser may wish to advertise several products for sale. The advertiser may have an ad campaign set that includes a campaign associated with advertising each product. Each campaign may utilize numerous tactics. For example, one utilized tactic may be sponsored search result listings. The advertiser may utilize multiple channels for this tactic. For example, the advertiser may utilize sponsored search listings in several Web sites or portals, such as Yahoo!, MSN.com, etc.

It is to be noted that channels can be, include, or be associated with affiliates. For example, an advertiser may arrange for an ad to be presented on MSN.com, so that MSN.com is a channel with respect to presentation of the ad. At the same time, MSN.com may be an affiliate. Furthermore, since affiliates can be channels, information communicated by affiliates can also be communicated by channels as depicted in FIG. 1.

Data obtained by affiliates and advertisers can include information that can be of great use in managing or optimizing ad campaigns. For example, ad campaign performance or user information obtained by an advertiser or by an affiliate through a user's use of a Web site of the advertiser or an outlet, portal, or media provided through the affiliate, can provide a rich source of information which can be used, analyzed, or mined to determine likely future performance of ads in various contexts, to various users, at various times, etc. The ad campaign facilitator, using the Server 102, is in an advantageous, centralized position to obtain, collect, and utilize, or facilitate utilization of, data from numerous affiliates and advertisers.

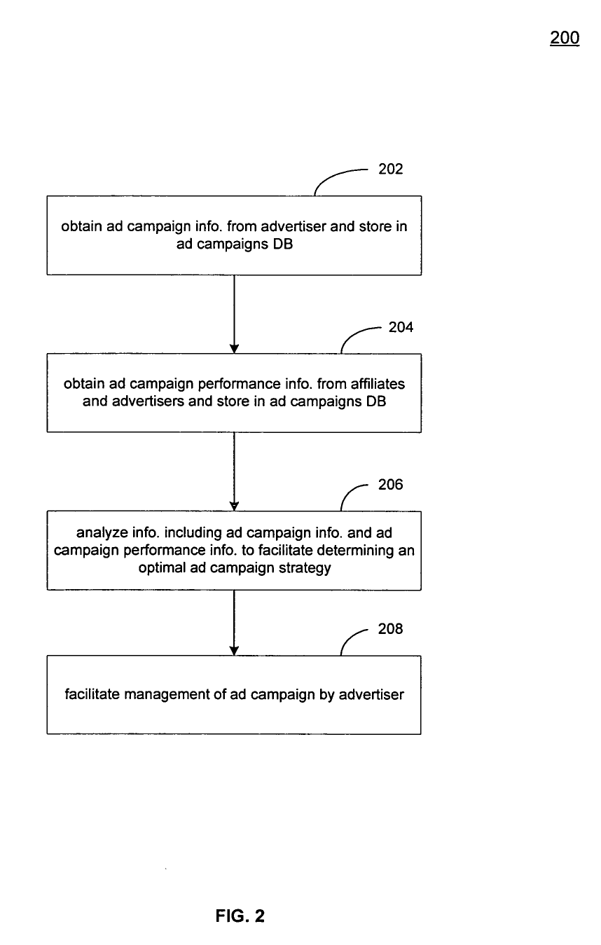

FIG. 2 is a flow chart depicting a method 200 according to one embodiment of the invention. At step 202, using an ad campaigns facilitation program 134 (as depicted in FIG. 1), ad campaign information from an advertiser is obtained by the Server 102 and stored in the ad campaigns database 136. In some embodiments, ad campaign information can be supplied in part or in total from one or more entities other than the advertiser. Ad campaign information can include parameters or specifics or an ad campaign. For example, ad campaign information can include campaign objectives or budget-related conditions or constraints, or can include information specifying, defining, or describing ads themselves, channels, tactics, etc. With regard to auction-based sponsored search result listings, ad campaign information can include bidding parameters such as maximum or minimum bids or bidding positions (rankings or prominence of listings) associated with a term or term cluster, for instance, as further described below. Such ad campaign information can also include campaign objectives, quotas or goals expressed, for example in metrics such as ROAS (return on ad spend), CPI (clicks per impression), or in other metrics, and with respect to individual ads, terms or term groups, channels, tactics, etc. as further described below.

At step 204, using the ad campaigns facilitation program 134, ad campaign performance information is obtained by the Server 102 from affiliates (or channels) and advertisers (or either affiliates or advertisers) and stored in the ad campaigns database 136. Ad campaign performance information can include a variety if information pertaining to historical performance of an ad campaign, channel, tactic, or ad or group of ads. Ad campaign performance information can include many types of information indicating or providing a suggestion of how effectively ads, or ads presented though a particular channel, etc., influence or are likely to influence user or consumer behavior. For example, an affiliate such as Yahoo! may collect performance information with respect to a particular sponsored search result listing. The information may include a number or percentage of viewers who clicked on the link, or who shopped at or purchased a product at the advertisers Web site as a result of the listing, etc.

In some embodiments, to facilitate tracking and collection of some varieties of ad campaign performance information, HTML tags are inserted in advertiser's Web sites or different pages thereof (as described in more detail with reference to FIG. 4)). In such instances, tagging may be facilitated by the ad campaigns facilitation program 134, and tagging programming or applications, wherever located and by whoever used, may be considered a part thereof. Additionally, ad campaign performance information and other information may be periodically or continually updated in the ad campaigns database 136 as new or updated information is obtained.

It is to be understood that obtaining ad campaign information and ad campaign performance information includes any necessary reformatting or translating of data, by methods known to those skilled in the art, to accommodate obtaining and storing data from disparate sources and disparate affiliates.

While not included in the method 200, in some embodiments, user information is also obtained from affiliates or advertisers. The user information can include user profile information, user behavior information, etc. Such information can be useful in targeting users for advertisements, for example, as detailed, for example, in previously incorporated by reference U.S. patent Application Nos. 60/546,699 and 10/783,383.

At step 206, using the ad campaigns facilitation program 134, obtained information, including ad campaign information, ad campaign performance information, as well as potentially other information, such as user information, is analyzed to facilitate determining, or to determine, an optimal ad campaign strategy. Herein, an “optimal” ad campaign strategy includes any ad campaign strategy that is determined to be optimal or superior to other strategies, determined to be likely to be optimal, forecasted or anticipated to be optimal or likely to be optimal, etc. In some embodiments, optimizing is performed with respect to parameters, or a combination of parameters, specified by an advertiser, supplied automatically or partially automatically by the ad campaigns facilitation program, or in other ways.

Furthermore, “ad campaign strategy” includes any course of action (including, for example, changing or not changing current settings or strategy) or conduct, or aspects or components thereof, relating to an ad campaign. An ad campaign strategy can include a recommendation regarding a course of action regarding one or more aspects or parameters of an ad campaign, and can include an immediate course of action or set of parameters, or a course of action or set of parameters for a specified window of time. For example, an optimal ad campaign strategy, in the context of an auction-based search result listings situation, can include recommendations relating to bidding and bid hiding rates in connection with an auction or marketplace relating to search term or group of terms in connection with sponsored listings.

At step 208, the ad campaigns facilitation program 134 is used to facilitate management of, or to manage, an ad campaign (or ad campaign set), for example, for or on behalf of an advertiser. In some embodiments, the ad campaigns facilitation program 134 facilitates the automated management of an ad campaign or campaign set. “Managing”, as used herein, includes any of a variety of activities relating to overseeing and making or implementing action or conduct decisions regarding one or more ad campaigns, or aspects thereof. In some embodiments, for instance, an advertiser is provided with one or more user-interactive computer applications to allow access, manipulation, and searching, such as relational database searching, of information in the ad campaigns database relating to performance of one or more ad campaigns or aspects thereof. An advertiser may, for example, specify parameters relating to ad campaign performance, such as by requesting to view, obtain a report of, obtain a summary of, or even download information regarding performance of a particular ad, a particular ad channel, a particular campaign or campaign element, etc. In an auction-based sponsored search result listings context, this may include obtaining summaries of ad performance, or ad campaigns performance, in connection with certain tactics or channels, etc. based on particular search terms or groups of terms. The ad campaigns database 136, which may contain a wealth of accumulated information from disparate affiliate and advertiser sources regarding ad campaign performance, is of great use in this regard.

Ad campaign management can also include managing or automatically managing ads themselves, such as by deleting or introducing new ads or listings, revising or changing ads, etc., all of which information can be stored in the ad campaigns database 136.

Furthermore, ad campaign management can include adding campaigns or campaign sets from new advertisers, or determining information relating to use of the ad campaigns facilitation program 134, such as what advertisers are logged in at a given time, etc. Such actions may be restricted, for example, to individuals associated with or employed by the ad campaign facililitator, or managers of the Server 102.

Management of ad campaigns can also include implementing or automatically implementing ad campaign strategies or actions. For instance, in an auction-based sponsored search result listings context, this can include carrying out bidding strategies.

In some embodiments, ad campaign management can include implementing or automatically implementing a determined optimal ad campaign strategy. An optimal ad campaign strategy may be automatically or partially automatically determined using the ad campaigns facilitation program. Once determined, the ad campaigns facilitation program can be used to automatically implement, or partially automatically implement, such strategies. Examples and embodiments of this in an auction-based sponsored search result listings context re described below.

It is to be noted that, in some embodiments, either ad campaign management or ad campaign optimization is facilitated, rather than both.

It is also to be noted that, in some embodiments, ad campaigns can be facilitated for or on behalf of an entity other than an advertiser, such as, for example, an advertising company associated with an advertiser.

Much of the following description relates to embodiments of the invention relating to sponsored search result listings, auction-based sponsored search result listings marketplaces, and related contexts. It is to be understood, however, that the methods and systems described in this context can be applied in a variety of other contexts as well, including other on-line contexts as well as, in some cases, off-line contexts.

In some embodiments, advertisers place HTML tags on relevant Web pages of their Web site to allow automatic tracking of ad performance or user behavior information to be sent to the Server and stored in the ad campaigns database 136. For example, HTML tags can be used to track user visits, interaction, or purchases from Web sites of an advertiser as a result of users clicking on sponsored links associated with the advertiser.

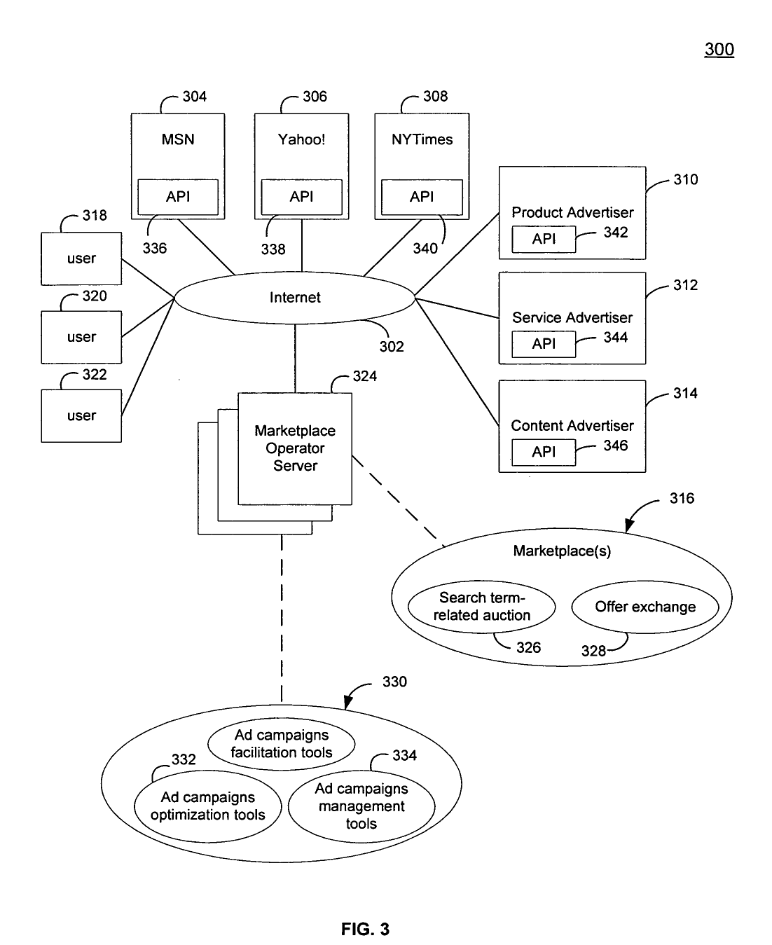

FIG. 3 is a block diagram of a networked computer system 300 according to one embodiment of the invention. As depicted, the Internet 302 connects one or more marketplace operator servers 324 with multiple Web site-based affiliates 304, 306, 308, multiple Web site-based advertisers 310, 312, 314, and multiple users 318, 320, 322. The marketplace operator server 324 can be or include one or more ad campaigns facilitation servers 102 (as depicted in FIG. 1). The affiliates 304, 306, 308, as depicted, include MSN 304, Yahoo 306, and the New York Times 308, and include associated Web sites or search engines. The advertisers 310, 312, 314, as depicted, include product advertiser 310, service advertiser 312, and content advertiser 314. The advertisers 310, 312, 314 include Web sites of the advertisers at which visitors or consumers can conduct such activities as purchase of products, services, or content. Visitors of advertiser Web sites include leads obtained from advertisements such as sponsored links (targeted leads), as well as other traffic.

The users 318, 320, 322 are presented with advertiser ads, such as sponsored links, while visiting a Web page of one of the affiliates 304, 306, 308. In some embodiments, the marketplace operator, using the marketplace operator server 304, facilitates arranging for presentation of the advertiser ads.

Communication between the affiliates 304, 306, 308 and the marketplace operator server 324, and between the advertisers 310, 312, 314 and the marketplace operator server 324 may be facilitated using APIs 336, 338, 340, 342, 344, 346. In some embodiments, APIs, such as XML-based APIs, can provide an interface with an ad campaigns database, to allow changes, for example, relating to ad listings themselves, or relating to bidding, or order or offer providing in search-term-relating auction 326.

As depicted, the marketplace operator server 324 is used to provide or facilitate providing a virtual marketplace 316 (or a set of virtual marketplaces). The marketplace 316 can include a search term-related auction 326 in connection with sponsored search result listings to be presented along with search results to users when users of affiliate search engines use particular search terms, groups of search terms, etc. in searches. The marketplace 316 can further include an offer exchange used to facilitate arrangements between affiliates and advertisers relating to ads, including suggesting and matching corresponding affiliate and advertiser offers. Additional features and detail relating to the marketplace 316 and its components, including offer exchange 328, can be found in previously incorporated by reference U.S. Application Nos. 60/546,699 and 10/783,383.

The marketplace operator server 316 also includes an ad campaigns facilitation program and ad campaigns database that are used to provide ad campaign facilitation tools 330, for example, to the advertisers 310, 312, 314. As depicted, the tools include ad campaigns optimization tools 332 and ad campaign management tools 334.

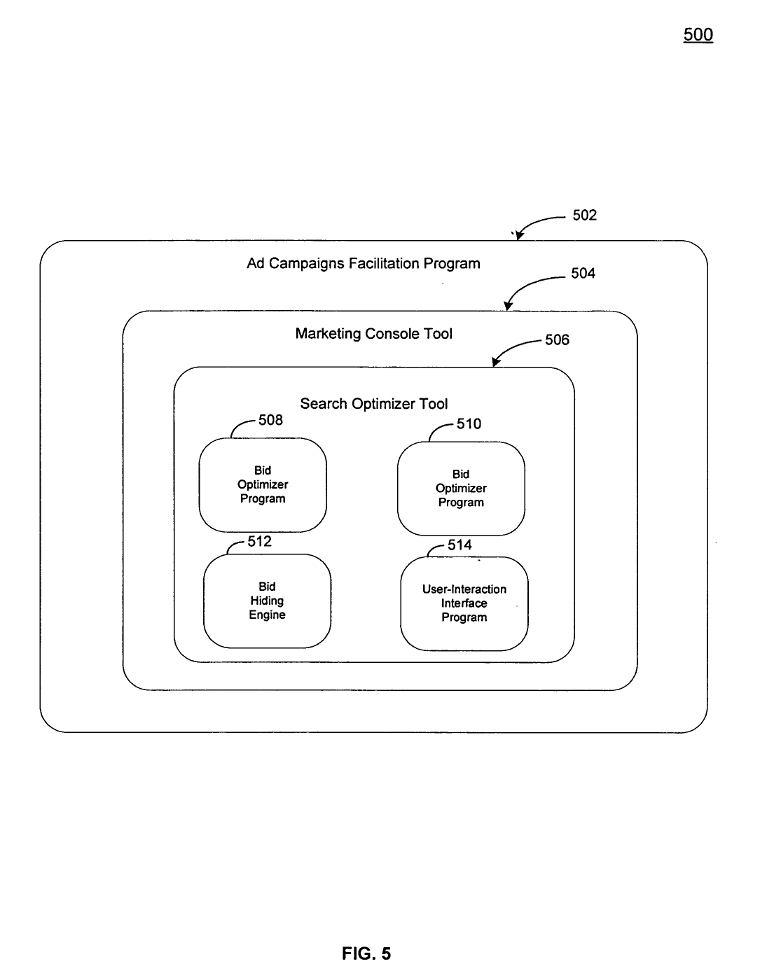

FIG. 4 is a block diagram 400 depicting tag-based automated data tracking and collecting according to one embodiment of the invention. Generally, tags and tagging, according to some embodiments, can be used to facilitate automated tracking of metrics including or relating to leads obtained via a sponsored listing and further user actions including conversions produced by such leads and revenue obtained by such conversions. This information can be of great value to advertisers or other Web site operators in assessing or analyzing, or allowing assessment or analysis, of the performance of sponsored listings and formulating strategies regarding their sponsored listings or bidding therefore. Furthermore, in some embodiments, the collected information can be used by an ad campaigns facilitation program according to some embodiments of the invention (including a bid optimizer and bid manager as depicted in FIG. 5, for example) to perform such analysis and formulation of strategies.

Some embodiments of the invention utilize or can be combined with features or technologies, such as, for example, HTML tagging, data tracking, and related technologies, as described in U.S. patent application Ser. No. 09/832,434, filed on Apr. 10, 2001, entitled, “SYSTEM AND METHOD FOR MONITORING THE INTERACTION OF RANDOMLY SELECTED USERS WITH A WEB DOMAIN”, and U.S. patent application Ser. No. 09/587,236, filed on Jun. 2, 2000, entitled, “SYSTEM AND METHOD FOR MONITORING USER INTERACTION WITH WEB PAGES”, each of which applications are hereby incorporated herein by reference in their entirety.

Internet-based traffic 410 is depicted visiting a Web page 404 of an advertiser. The traffic 410 includes leads 402, which are hits on the Web page 404 resulting from users clicking on a sponsored search result listing of the advertiser, as well as other, non-lead traffic 412. After visiting the initial Web page 404, visitors may then click on links to go to another page, or pages, associated with the Web site, such as depicted pages 406 and 408. At some point, the user may, for example, place goods in a shopping cart, or actually make a purchase. The progress of the user deeper into the advertiser's (or other entity's) Web site, ultimately culminating, in some instances, in a purchase, is known as a funnel 414. As depicted, tags 416 are included on the advertiser Web pages (or selected such pages).

In some embodiments, the HTML tags 416 facilitate automatic tracking, collection, and use of traffic and collection of information that is then sent, for example, over the Internet to the Server 102 and stored in the ad campaigns database 136. Using tags, leads can be distinguished from other traffic, and, depending in part on the configuration of the advertiser's Web page, tracked information 416 sent to the Server 102 can include the number, frequency, and time of hits on various Web pages, the deepest stage into the funnel for particular leads, whether shopping was conducted, whether a purchase was made, the type or amount of a purchase, and other information. In some embodiments, advertisers are helped through tagging or instrumenting their Web sites or pages, via applications provided using an ad campaigns facilitation program 134 (as depicted in FIG. 1).

In some embodiments, after initial instrumenting by an advertiser (or other Web site operator), new pages added to the site are automatically appropriately tagged.

In some embodiments, tags facilitate the passing of transaction ID values to the Server 102. A transaction ID value is a unique value that is generated as a result of user activity, such as shopping activity, at an advertiser Web site. Transaction ID values can facilitate distinguishing between multiple shop and conversion events that occur within a single browser session. For example, if a second conversion event for the same revenue amount in a single browser session is detected, it may not be obvious whether such a purchase has actually occurred, or if the visitor has just refreshed or returned to the Web page with the conversion tag. However, generating a new transaction ID value for the second transaction makes it clear that a second conversion has occurred. In embodiments that do not use transaction ID values, an assumed limitation of one shopper and one conversion per browser session may be utilized.

In some embodiments, tagging includes placing a universal tag on all Web pages in the header. Further, conversion tags are placed above the universal tags on the transaction completion page, such as a “Thank You” page or a purchase confirmation page. The universal tag consists of code used to capture any customer-specific information associated with the tracked HTML page. The universal tag calls a piece of JavaScript, called Instrumentation Script, and marks the pages the advertiser desires tracked. In some embodiments, the Instrumentation Script is about 6 KB in length. Furthermore, in some embodiments, user activity is collected by the Instrumentation Script and sent to the Server 102 using a 1X1 .gif image request. The Instrumentation Script is downloaded the first time an end user views a tagged page. The Instrumentation Script (which can be part of an ad campaigns facilitation program 134) is provided from the Server 102 (or one of many Servers 102 which may be located at many different geographic locations, which can include worldwide locations). The instrumentation script is only downloaded into the visitor's browser on the first page load for the session. After the first load, the browser caches the script, ultimately creating a cookie. The script will not be downloaded again unless the user flushes his or her browser cache.

The universal tag also identifies and gathers statistics for the pages in which it has been embedded. When the browser leaves a tagged page, the instrumentation script is halted and gathers no more data, due to the inherent security aspects of JavaScript. Once the instrumentation script is activated within the browser, the data collected is sent via a 1X1 pixel .gif image request.

The instrumentation script returns two data packets per page view: one packet when the page loads and one packet when the page unloads (i.e., when the visitor transitions to the next page). About 500 to 800 bytes in total are transmitted per page. Each data transmission occurs entirely in the background with no visitor impact, even for those with a slow modem connection. In some embodiments, it takes, on average, about 0.21 seconds for each data transmission to reach a Server 102. If a data transmission fails to take place, the Instrumentation Script is halted and gathers no more data.

Additional tags are utilized in some embodiments. For example, a shopper tag may be used to indicate that a visitor has visited a page that indicates that the advertiser considers the visitor to be a shopper. In the absence of a shopper tag, a default rule may be used which specifies that transition of a visitor of the site from an unsecured page to a secured page indicate that the visitor is a shopper.

In some embodiments of the invention, in an auction-based search result listings context, the ad campaigns facilitation program 134 is used in optimizing and managing bidding strategies in the auction, the bidding being by advertisers in connection with search terms, groups of terms etc.

In one embodiments of the invention, the ad campaigns facilitation program 134 includes a set of software and programming tools that include applications accessible by advertisers via the Internet. The software tool set is offered by an ad campaign facilitator that is also a marketplace operator for an auction-based sponsored search result listings marketplace.

FIG. 5 is a conceptual block diagram 500 depicting an ad campaigns facilitation program 502, and some conceptual components or modules thereof, according to one embodiment of the invention. The ad campaigns facilitation program 502 includes a set of software and programming tools available to advertisers via the Internet, called the Marketing Console tool 504. The Marketing Console Tool 504 includes Search Optimizer Tool 506 (or simply, Search Optimizer 506). The Search Optimizer Tool 506 includes, among other things, a Bid Optimizer Program 508 (or simply, Bid Optimizer 508) a Bid Manager Program 510 (or simply, Bid Manager 510), and a bid hiding engine 512. While depicted as separate from the Bid Optimizer 508 and Bid Manager 510, in some embodiments, the bid hiding engine can be part of the Bid Optimizer 508, the Bid Manager 510, or both, or can be partially or completely separate from them.

In some embodiments, the Search Optimizer 506, or its components, can include or allow for configuration by a user, such as an advertiser, to allow the use the user to align or set the tools according to the user's specific and unique business objectives. For example, a user may make particular decisions regarding how to tag their Web pages (as described in more detail previously with reference to FIG. 4) to suit the user's business logic and business objectives.

Advertisers use the Marketing Console Tool 504 to facilitate optimizing, managing, or both optimizing and managing ad campaigns or ad campaign sets. The Marketing Console Tool 504 can facilitate these activities automatically after being provided with any necessary parameters and ad campaign information by the advertiser, or partially automatically with decision-making input from the advertiser, or may facilitate advertiser analyses of ad campaign performance to optimize ad campaigns, and facilitate advertiser management, including decision-making and implementation of ad campaign management strategies.

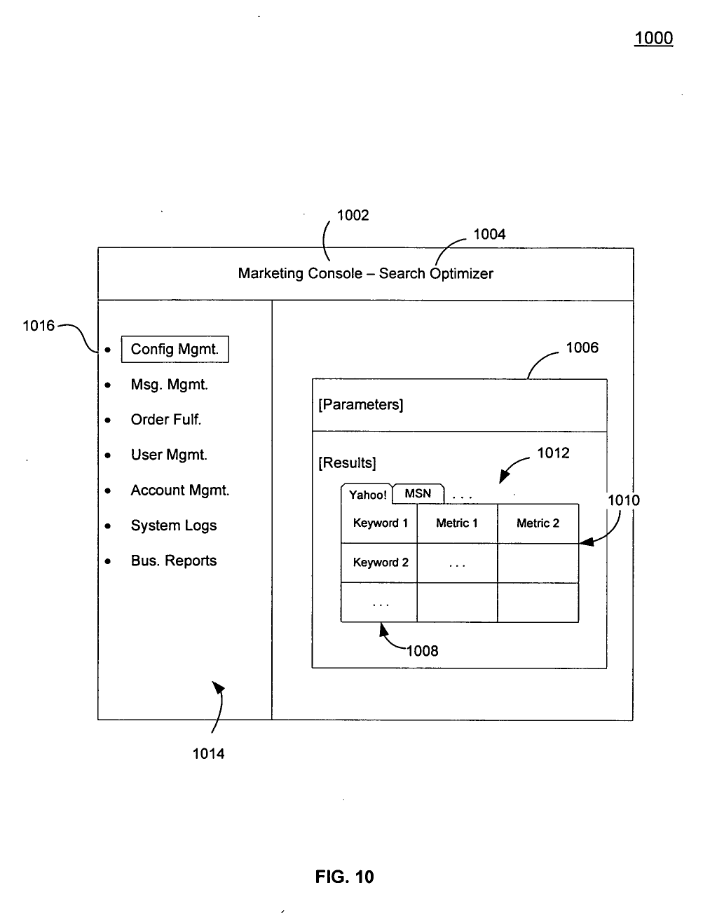

The Search Optimizer 506 can also include a user-interactive interface program 514 to allow, for example, user access to and changing of information stored in an ad campaigns database (more detail regarding a user interface is provided with reference to FIG. 10).

It is to be noted that, while the role of the Bid Optimizer 510 and Bid Manager 512, as the names suggest, can include, respectively, facilitation or performance of ad campaign optimization and ad campaign performance, their roles are not limited to such functions, they may not themselves perform all aspects of such functions, and their roles in connection with such functions may overlap or partially overlap.

In some embodiments, as mentioned with reference to FIG. 5, the marketplace operator provides, among other things, a virtual marketplace (which can include numerous marketplaces), that can assist advertisers in acquiring targeted leads. An Internet user may indicate what he or she is looking for every time he or she uses a search engine. The advertiser and the Internet user both benefit when product information that is relevant to the search is served.

The marketplace operator may be associated with, for example, a world-wide network of search engine affiliates (among potentially other affiliates) that participate in the marketplace, including Yahoo! and MSN, as well as other more localized portals and search engines. For the participating affiliates, two important features of the marketplace operator network are the relevance of the results and the time required to fulfill the search request.

In some embodiments, when the Internet user performs a search, the portal sends a request to a marketplace operator server to retrieve paid search results (or listings) that are, or evidenced as likely to be, relevant to the user's search. In parallel with the request for paid results, the portal sends a separate request to an “algorithmic” search engine to retrieve results discovered from the Internet and ranked by relevance. The algorithmically determined listings are displayed in order of relevance, and the paid results are displayed in order of bidding position, relevance, or both. For paid search results, the marketplace operator hosts an auction for each search phrase and ranks the results based on the bids.

The marketplace operator may ensure relevance of advertisers' listings, or some of them, through a strict human editorial review before a listing can participate in the auction. Editorial review can be used, for example, to ensure that a sponsored listing sufficiently corresponds to an associated search term or term group, such as ensuring that the title, description in the listing correspond, or that the content of a linked Web page corresponds. In some embodiments, editorial review can is limited to search terms or term groups that are used most frequently and generate the most traffic (or “high velocity” terms, as discussed in more detail below), and that are therefore considered important enough to warrant the effort and expense. While human editorial review can be costly and time-consuming, it can be the only way to ensure a high degree of relevance among sponsored listings, which can inspire greater confidence in users of such links and users of Web sites or search engines that provide them.

The marketplace auction in each marketplace is updated continuously or frequently. Advertisers that have a listing authorized to participate in the auction can make arbitrary and frequent changes to their bid as well as bring the listing online and offline. When a search result set is requested by an affiliate, the current or most updated state of the auction determines the listings that will be served. If the Internet user clicks on one of the marketplace operator-served listings, an HTTP request goes to a marketplace operator server, the advertiser is billed for the click, and the Internet user's browser is redirected to the relevant page on the advertiser's web site. For example, in some embodiments, the advertiser may be billed $0.01 more than the next lower bid in the auction, bound by a minimum of $0.10 and a maximum of the advertiser's bid. In the case of ties (equal bid amounts from multiple advertisers), and the listings may be ranked in the order the bid was placed. All but the last placed listing at the tied bid will pay the full bid amount for each click.

Some marketplace auctions are stable, while others have scores of advertisers constantly jockeying for position, getting into bidding wars, etc. Some advertisers change their bids infrequently, while others change their bids as often as possible.

Bid changes may be effected in different ways. In some embodiments, bid changes are effected either manually through a marketplace operator web application, or by using software programs that automate the process through an API, such as an XML-based API, which can allow communication with marketplace operator servers and changes to data in databases (such as the ad campaigns database 136 as depicted in FIG. 1).

In some embodiments, when an advertiser changes the bid associated with a listing, the new state of the auction must be made available to all computers (or servers) that are serving search results for that marketplace. As noted above, the response time for search-serving can be critical, so computers to serve these results are replicated throughout the world, as proximate as possible or practical to the affiliate's servers that are requesting the search results to minimize network latency. The distributed nature of search serving places a burden on the marketplace operator infrastructure to replicate all bid updates to all relevant search-serving sites in near real-time. The replication of a bid update has a measurable cost in infrastructure, bandwidth and labor to support the systems.

Due to the costs, system requirements, and potential delays associated with replication or excessive replication, in some embodiments, advertisers are limited to the total quantity or frequency of bid updates associated with the advertiser, the advertiser's campaign set, or one or more components thereof. For example, the advertiser may be limited to a certain number of bid updates per day per bid subjects, such as a search term or group. The advertiser may also be limited in a cumulative manner, such as by being limited to a total quantity (or “pool”) or frequency of bid updates per day for a certain number of bid subjects, or be limited to a certain average bid update quantity or frequency per day per certain number of ads, etc. In some embodiments, advertisers pay for updates, or available updates could be based on advertiser spending. Since updates may be a limited and valuable resource, it may be wise for an advertiser to apportion available bid updates differently for different search terms or search term creatives.

For example, an advertiser may wish to use higher bid update rates for more important or valuable search term creatives, or for search term creatives in more volatile markets, and compensate by using lower bid update rates for less important or valuable search terms or groups, or for search terms or groups in more volatile markets. In some embodiments, the Bid Optimizer 408 determines bid update periods, for example, based on such factors. This can create a more rational, optimal, or profit-maximizing approach than utilizing a uniform update rate for all listings regardless of value. The less frequently updated listings can offset the more frequently updated listing. For example, listing limits may be cumulative, so that if an advertiser uses less than the limit for one or more listings, that advertiser may be allowed to use that much more for one or more other listings, provided that the cumulative limit is not exceeded. Methods for calculating, determining, or estimating value are described further below.

One technique that can be useful to advertisers or other bidders in, for example, the above-described auction-based scenario is called bid hiding (or maximum bid hiding). Bid hiding is a technique that can be employed manually, such as by advertisers themselves, who may utilize the ad campaigns facilitation program 134 in this regard. In some embodiments, however, bid hiding is automatically employed, for example, by the Bid Manager 510 or Bid Optimizer 508 or both.

Bid hiding can include a strategy used by a bidder for a listing in a listing auction. Suppose, for example, that a bidder has or is prepared to offer a certain maximum bid, or highest bid that the bidder is willing to submit, or to potentially submit. The bidder, however, may wish to avoid exposing this maximum bid to other bidders during the listing auction. The winning bidder may be billed a certain amount, such as $0.01 per click more than the next lowest bidder in the auction, which is not necessarily what the winner actually bids. Exposing the bidder's maximum bid can be disadvantageous to the bidder, for example, by subjecting the bidder to malicious bidding strategies. Such malicious strategies can include a second bidder bidding just below the first bidder's maximum bid, ensuring that the first bidder, assuming the first bidder wins the listing, will in fact be billed based on the first bidder's maximum bid. Additionally, exposing the maximum bid lets potential competitors know that the bidder is willing to bid, which can be undesirable for the bidder.

Bid hiding, or maximum bid hiding, is a technique in which a bidder bids only as much as the bidder would expect to be billed if the bidder submitted the bidder's maximum bid, which billed amount, as discussed above, may be below the bidder's maximum bid. A system governor, which can be, for example, programming or a software module included in an ad campaigns facilitation server(s), may be used in connection with the auction, which system governor limits the amount of updates per advertiser per listing day, an update period being the time between maximum bid hiding updates.

For example, suppose that the marketplace operator exposes the state of the auction, including all maximum bids and the advertisement associated with each bid (even though clicks are billed at $0.01 above the next lower bidder). Bid hiding seeks to hide the advertiser's maximum bid by bidding exactly the amount they would expect to be billed if they submitted their maximum bid into the auction. Not only does this protect the maximum bid from scrutiny by competitors, it inhibits some malicious bidding strategies, such as bidding $0.01 below a competitor's bid, so they pay their maximum bid for each click.

In some embodiments, the Bid Optimizer 508 can include programming, software, or one or more applications, which can be configurable by an advertiser-user, useful in determining a desirable or optimal bid by the advertiser for a listing such as a paid search result. Configuring by a user can include, for example, the user setting the targets and constraints. The constraints can include a maximum bid and a minimum bid. The targets can be associated with the listing and can be specified in terms of one or more metrics related to the performance of the listing. The Bid Optimizer 408 can analyze recent past analytics in connection with the metric and specify a bid recommendation forecasted by the bid optimizer to achieve the target or get as close to the target as possible. The Bid Optimizer 408 can provide a recommendation for a listing which can include a maximum bid and an update period, which update period can be a time between maximum bid hiding updates

In some embodiments, a bid update rate governor, which can be, for example, programming or a software module that is part of an ad campaigns facilitation program, is used to limit the marketplace operator's replication cost, but also limits the ability for advertisers to control their position in the auctions most important to their business. Some embodiments of the present invention therefore provide a solution to this problem by aligning the marketplace operator's cost structure with the advertiser's business objectives.

One approach would be for the marketplace operator to bill the advertiser for bid updates. This would cover the marketplace operator's costs associated with replication and provide the advertiser with an incentive to use bid updates efficiently. This could result in rational decisions by the advertiser regarding the real value of each bid update. This approach may not be practical under some circumstances for a number of reasons, including the perception that auction participants should not be billed just to participate (this could be considered contrary to a pay-for-performance business model).

In some embodiments, the bid update frequency is adjusted for listings based on the value provided to the advertiser by that listing; the more value, the more frequent the bid updates. It is generally the case that a small fraction of the listings provide the bulk of the value for any given advertiser, so a decrease in the bid update frequency for the many low-value listings is used to offset a significant increase in the bid update frequency for the high-value listings. The benefit for the advertiser is significant, while the overall number (and therefore cost) of bid updates is kept constant or reduced.

A first embodiment of the invention is deployed with special access to an XML-based API such that the bid update rate governor is not enabled—the value-based bid update rate is controlled internally to a bid hiding engine that can be part of the Bid Manager 410. An alternate embodiment would be for the governor to be modified to enforce the value-based bid update rate.

There are many possible definitions for “value” for a listing in this context, including the advertiser's spend rate on the listing, and the advertiser's revenue rate generated by leads from the listing. In some embodiments, “value” is calculated using the Bid Optimizer 508.

In some embodiments, listing value is determined based on spend rate S of the listing. Studies have indicated that, in some situations, 90% of the advertiser's spend is concentrated in just 1% of the listings. That means, for example, that if all these listings were getting bid updates at the maximum rate and one was to reduce the bid update rate by half for the lowest-spending 99% of the listings, one could increase the bid update rate on the top-spending 1% of listings to 100 times the previous rate, while not increasing the overall number of bid updates.

In the first embodiment, the following formula is used:
R=min(max(M×S,Rₘᵢₙ), Rₘₐₓ) (1)
where
R is the value-based bid update rate in units of minutes between bid updates for the listing.
S is the advertiser's recent spend rate on the listing in units of

$$\frac{minutes}{dollar} .$$

If the listing has resulted in no clicks and therefore no spend, one can use

$$S = \frac{{R}_{max}}{M} .$$
M is the spend required per bid update in units of dollars. M can be a constant value such as M=2.00, or it can be dynamically updated to reflect changes in bid update cost.
Rₘᵢₙ is the minimum time allowed between bid updates in units of minutes. In the first embodiment, a constant Rₘᵢₙ=5 is used, although a different constant could be used, or it could be varied dynamically.
Rₘₐₓ is the maximum time allowed between bid updates in units of minutes. In the first embodiment, a constant Rₘₐₓ=1020 is used, although a different constant could be used, or it could be varied dynamically.

To determine S, one looks back at the “recent” activity associated with the listing. In this context, recent should look far enough back in time to gather a significant enough data set that it will be relatively stable, but not so broad as to hide recent changes in the spend rate. One can define the duration of how far one looks back as D in units of minutes, and the cost C in units of dollars to the advertiser during the duration D. Then,

$$S = \frac{D}{C}$$

In some embodiments, it is desirable, but not necessary to limit D, so one does not have to consider an unbound amount of data. In the first embodiment, the maximum value for Dₘₐₓ is 30 days. There are a number of strategies for determining the relevant data set to consider: For example, one approach is to look back far enough to capture a certain amount of spend, e.g., C≧10. This strategy has the drawback of being invariant to the cost per click. Another approach is to look back a fixed duration, e.g. three days. This strategy has the drawback of being insensitive to high frequency changes in the spend rate. Another approach is to look back far enough to capture a certain number of clicks, e.g., at least 100. This is the strategy used in the first embodiment.

In some embodiments, the Bid Optimizer 408 is a forecast-based, budget-aware optimizes the spending of a limit budget on paid placement networks. The infrastructure to support forecast-based optimization is non-trivial. A sort of bid optimization is provided in a shorter time frame, and a backward-looking control-loop optimizer is used to recommend maximum bids.

In some embodiments, a user interface provides an advertiser option of executing the recommended change on behalf of the advertiser. The user can set the account to automatically accept recommendations as they change, or manually accept recommendations.

A user, such as an advertiser, may choose a metric (CPA or ROAS, for example) and provide a target value for the metric. The current value for the metric is measured over the recent past and the recommended maximum bid is adjusted up or down in an attempt to get closer to the target.

In some embodiments, implementations support various matching schemes or selections, such as a matching scheme that re that an exact search term or terms be entered to cause a listing to be presented, or a matching scheme that requires only that a term or terms appear somewhere in a search, etc.

In some embodiments, the advertiser configures the Bid Optimizer 408 by setting targets and constraints. For example, in some embodiments, the user specifies a target CPA (cost per acquisition). The user also specifies a maximum CPA, which is used (in conjunction with the CPA target) to determine if the offer is successful. Optionally, the user can also specify up to two constraints: maximum bid, minimum bid (some embodiments can include two additional constraints: maximum position and minimum position). These targets and constraints can be specified at the following levels: global default (across an entire campaign set, for example), campaign default, and creative. These levels form a hierarchy: if no value is specified at the creative level, the value from the campaign level is used; if no value at the campaign level is specified, the global default is used.

In some embodiments, targets are required and therefore only two states are available: either a value or “inherit” (inherit is not available for the global default). Constraints are optional and can have one of three states: a value, “inherit” or “none” (except at the global level, where “inherit” is not available). The targets (and the analytics) guide the Bid Optimizer's 408 choice of a recommendation and are used to determine how to evaluate the success of the offer. In some embodiments, all optimization and evaluation is done at the level of offers.

The constraints (and the Bid Optimizer's 408 recommendation and current marketplace state) guide the Bid Manager's 410 bid updates. On import, listings with a current bid of less than $0.10 will have maximum bid constraint and minimum bid constraint set to the current bid. All other listings will inherit constraint values on import.

In some embodiments, the Bid Optimizer 408 looks back in time (up to 30 days) for analytics related to impressions, leads, conversions, cost, revenue, etc. First, it gathers the analytics for a period of time back far enough to cover at least 10 conversions. If zero conversions are found, it goes through the same process, but looking to cover at least 1,000 leads. If zero leads are found, it then tries to cover at least 10,000 impressions. The period of time to cover the required number of events (conversions, leads or impressions) is referred to as the aggregation period. Based on the analytics, the Bid Optimizer makes and updates recommendations for each listing.

In some embodiments, a recommendation for a listing consists of a maximum bid and the update period (time between maximum bid hiding updates—see Bid Manager for how this value is used). Each listing receives a recommendation based on the analytics and the dynamics of the marketplace for that listing.

In some embodiments, the bid recommendation for a listing is checked/updated when at least one of these conditions is met: (1) at least 20% of the aggregation period has passed since the last check; (2) if zero conversions were found in the aggregation period, at least 20% of the time required to spend the target CPA has passed since the last check. In other words, if the target CPA is $10 and the aggregation period is 100 hours and the cost during the aggregation period is $100, the time required to spend the target CPA is 10 hours—so this rule would trigger a check every 2 hours; (3) it has been at least one day since the last check.

In some embodiments, the update period is determined from the following formula (proportional to spend rate), where, for each listing, the recommendation is updated with the first rule that matches. In the following, “Impr” means “impressions”, “Conv” means “conversions”, and “CPA” means “cost per acquisition”.

TABLE 1

| List- | | | | | Cost | |
|---|---|---|---|---|---|---|
| ing | | | | | in Aggre- | |
| On- | | | | | gation | |
| line? | Impr | Lead | Conv | CPA | Period | Action |
| No | 0 | * | * | * | * | Recommend current |
| | | | | | | bid and disable bid |
| | | | | | | hiding |
| * | * | * | >0 | =Target | * | Do not change the |
| | | | | | | recommendation |
| * | * | * | ≧10 | <Target | * | Increase bid to $0.10 |
| | | | | | | above the next higher |
| | | | | | | position in the |
| | | | | | | Precision Match |
| | | | | | | marketplace |
| * | * | * | ≧10 | >Target | * | Decrease bid to $0.01 |
| | | | | | | below the next lower |
| | | | | | | position in the |
| | | | | | | Precision Match |
| | | | | | | marketplace |
| * | * | * | <10 | <Target | * | Increase bid by $0.01 |
| * | * | * | <10 | >Target | * | Decrease bid by $0.01 |
| * | * | >0 | 0 | N/A | <Target | Increase bid by $0.01 |
| | | | | | CPA | |
| * | * | >0 | 0 | N/A | ≧Target | Decrease bid by $0.01 |
| | | | | | CPA | |
| * | >0 | 0 | 0 | N/A | * | Increase bid by $0.01 |
| Yes | 0 | 0 | 0 | N/A | * | Increase bid by $0.01 |

In some embodiments, the assumption is made that, for a given offer, the rate at which leads convert is the same for all bid positions.

In some embodiments, the Bid Manager 410 always performs maximum bid hiding by attempting to bid $0.01 above the next lower bid.

In some embodiments, the Bid Optimizer's 408 recommendation for a listing consists of a maximum bid and the bid update period. The Bid Manager 410 checks/updates a listing's bid at the end of each update period. Under certain circumstances, an unscheduled check/update of the listing's bid is implemented. The circumstances are: (1) the constraints change and the current bid violates the new constraints. These bid updates are top priority; (2) the recommended maximum bid changes.

Whenever a listing's bid is checked/updated (scheduled or unscheduled), the next check of the bid is scheduled based on the recommended update period. Each time the Bid Manager 410 manages a listing's bid, it examines the marketplace state, the recommendation and the constraints. It limits the recommended maximum bid with the constraints (including the marketplace state for the position-based constraints) to generate the maximum bid. If the constraints can be satisfied, the marketplace state is examined to see if there is an existing competitive bid that equals the maximum bid. If so, the current bid is the maximum bid. If not, the marketplace state is examined to find the highest competitive bid that is less than the maximum bid. If such a bid is found, the current bid is $0.01 above that bid. If no lower bid is found, the current bid is the minimum bid. If the previous current bid equals the new current bid, no update is required. In either case, the next-update time is set to the current time plus the recommended update period.

In some embodiments, a system governor is put in place that limits the bid update rate and the marketplace state check rate, which can decrease replication load.

It is noted that backward-looking control-loop optimization is susceptible to interactions between the convergence rate of the Bid Optimizer 408 and the rate of change in the system under control. For example, assume that due to variations in the Web surfing population throughout the day, conversion rates vary by a factor of two from noon to midnight in a 24 hour cycle. If the control loop is able to measure over a short, recent period (say a couple of hours) and converge quickly, then the daily cycle will be tracked reasonably well. However, if there is a bad mismatch, the control loop will be raising bids while the conversion rate is dropping and lowering bids while the conversion rate is rising. If the control loop looks back over several days to evaluate current performance, then the daily cycle will not significantly affect the recommendation and the bid will remain relatively steady and not track the daily cycle.

In some embodiments, different classes of bid changes are separately controlled. For example, in some embodiments, automate recommendation changes of less than $0.05 are automated, but explicit approval is gotten for anything larger. In some embodiments, bid increases are automated, but not bid decreases.

Determining statistical significance of rate metrics involves several considerations. In general, one would like to measure enough of the outcome events to determine the rate (with error bars). For example, by the time one sees 100 conversion events, one has a good idea of what the lead-to-conversion rate is, even if that rate is very small. However, suppose that after measuring 100 leads, one has seen one conversion. In this case, one cannot say with confidence what the rate is. However, one can put some bounds on it; for example, one is confident that the rate is much less than 75%. It is needed to characterize how many outcome events one needs to measure to have confidence in the rate estimate, as well as how the confidence in the rate maximum is a function of the number of source events measured.

In some embodiments, configurable parameters include data retention period, N—The number of impressions/leads/conversions required for statistical significance, and the delay between successive recommendation updates, and the recommendation step size.

The delay should be expressed as a function of the function of the time to achieve N impressions, leads or conversions. This allows high inventory offers to have tighter control loops. There should be a maximum delay, so offers that are getting no/low traffic still get recommendation updates. If day-parting is done, then the delay needs to be expressed in such a way that it makes sense when data is only collected for a given day-part every 24 hours or every seven days.

The recommendation step size may be adaptive and possibly gap-aware. It also could be sub-penny to slow down the rate of change.

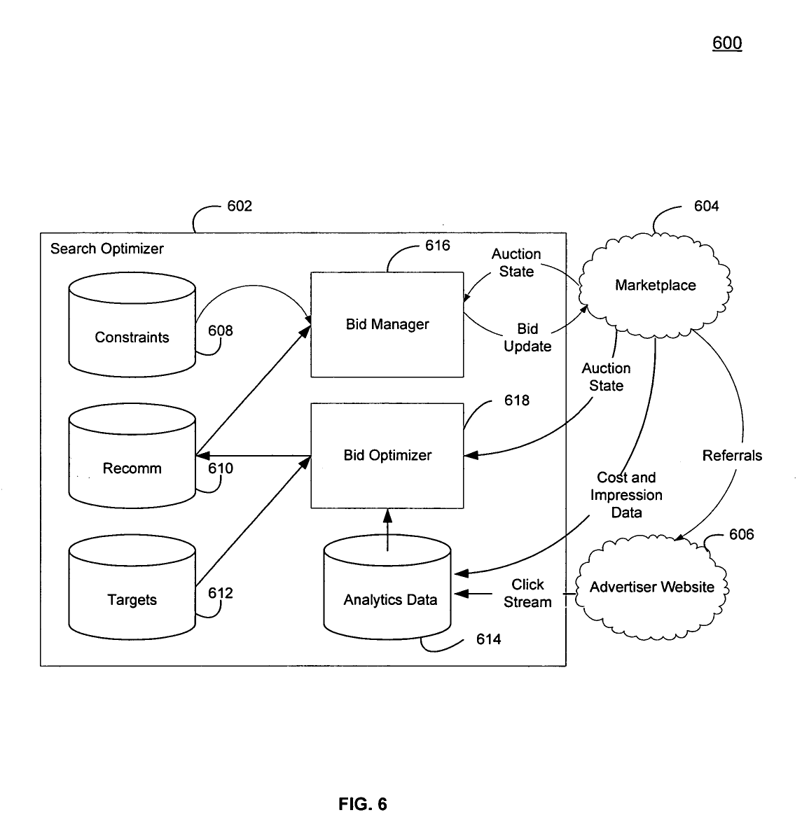

FIG. 6 is a block diagram of a system 600 according to one embodiment of the invention. As depicted, the system 600 includes a Search Optimizer 602, which can be part of an ad campaigns facilitation program, a marketplace 604, which can be provided or facilitated by a marketplace operator, and an advertiser Web site 606. The Search Optimizer 602 includes a Bid Manager 616 and a Bid Optimizer 618. The Search Optimizer 602 further includes databases including a constraints database 608, a recommendations database 610, a targets database 612, and an analytics database 614. The databases 608, 610, 612, 614 can be part of an ad campaigns database. Data flow is depicted, including target information being sent to the Bid Optimizer, recommendation information being sent to the recommendation database 610 from the Bid Optimizer 618, and constraint and recommendation information being sent to the Bid Manager. Other depicted data flow includes auction state information sent from the marketplace 604 to the Bid Manager 616 and the Bid Optimizer 618, Bid Update information being sent to the marketplace 604 from the Bid Manager, referrals (leads) as well as cost and impression data being sent from the marketplace 604 to the advertiser Web site 606, and click stream information being sent from the advertiser Web site 606 to the analytics database 614. The depicted information flow is not intended to be comprehensive or limiting.

As described above, in embodiments of an auction-based sponsored search result listings environment, prominence or rank of listings can be important to ad performance, and therefore relevant to ad campaign optimization. The rank is important to the advertiser, because it determines the quality of the placement of their listing on the page that is displayed to the user. Although the details vary by affiliate (search engine), a typical layout is as follows. The top-ranked listings appear at the top of the page, the next listings appear in the right rail and additional listings appear at the bottom of the page (usually out of view without scrolling). Listings ranked below the top five or so will appear on subsequent search results pages.

There is a strong correlation between rank and both number of impressions and click-through rate (clicks per impression), which provides an opportunity for advertisers to pay more per click (get a higher rank) in order to get more visitors to their web site. The result is that the advertiser needs to or should determine, or have determined on the advertiser's behalf, how much the advertiser should be willing to bid for each listing based on the advertiser's business objectives and the quality of the traffic on their web site that is generated by the listing.

In the embodiment depicted in and described with reference to FIG. 6, a conceptual distinction is maintained between bid management and bid optimization. In this embodiment, bid management involves deciding exactly what bid to submit to the auction at any given time, where the decision is based on the maximum bid we one is willing to submit and the other bids that are exposed in the auction. One common bid management strategy is bid hiding, which involves bidding exactly the amount that you will pay per click, and which has been described above. In this embodiment, bid optimization involves the determination of the maximum amount one is willing to pay per click for a listing at any given time. It is to be noted that the distinctions between bid management and bid optimization apply only to certain embodiments, including the embodiment depicted and described with reference to FIG. 6. Other embodiments do not necessarily include such a distinction.

The task of bid optimization can be daunting for advertisers. The advertiser has to measure the quality of traffic for each listing by tracking the behavior of individual users on the web site and associating the outcome with the listing that introduced the user to the site. Both the user behavior and auction dynamics can change continuously, and the advertiser may have many thousands of listings to manage. The difficulties associated with optimizing paid search bids, combined with the importance of the paid search channel to advertisers has spawned the growth and importance of Search Engine Management (SEM) providers. An SEM utilizes a combination of bid management experience and software tools to facilitate the advertiser's performance measurement, bid management and bid optimization.

One aspect of the optimization problem is due simply to the large number of listings, which can be addressed with software automation. Another aspect to the problem is the distribution of traffic across the listings. In a study sample of advertiser account activity with a marketplace operator, for a one month period, it was found that 90% of the advertiser's spend is concentrated in just 1% of the listings. The skew of the majority of the traffic to the minority of the listings means that there are a small number of “high velocity” listings. The high velocity listings generate enough conversions to enable unambiguous evaluation of performance against business objectives. However, one runs into the problem of too much data. The large amount of accumulated data from a high velocity term creates significant “inertia” that reduces the impact on measured performance from current bid changes.

The vast majority of the listings are “low velocity.” Here, the problem is that the search term associated with these listings are highly specific and are relevant to few searches. There also tends to be less competition in the low velocity auctions, so the cost per click tends to be lower. The specificity of the of the low velocity listings often results in higher conversion rates than the more general, high velocity listings. While there is significant value in the low velocity terms, there is not enough performance data to enable unambiguous evaluation of performance against business objectives. This means that the optimization methods used for high-velocity terms do not work for low-velocity terms. To summarize, the advertiser has numerous listing to manage and all of the listings tend to have either too much or not enough performance data.

As depicted in FIG. 6, the Search Optimizer 602 includes a user-interactive Web application (or applications) to help the advertiser automate both bid management and bid optimization. The web application allows the advertiser to configure the automated collection filtering and aggregation of analytics data, as well as view the analytics data in a set of reports. In addition, the web application allows the advertiser to specify business performance targets for optimization and bidding constraints. Optimization targets types include or are expressed or indicated in terms of, potentially among other things, Cost Per Acquisition (CPA), Return On Ad Spend (ROAS) and Constraints-Only (non-performance-based optimization). Constraint types for bid management can include, potentially among other things, minimum bid, maximum bid, minimum position and maximum position.

The optimization component in the system 600 depicted in FIG. 6 is the Bid Optimizer 618. The Bid Optimizer 618 produces recommendations which consist of a maximum bid and value-based bid-hiding rate. A recommendation is based on cost and impression data from the marketplace 604 or marketplace operator, click stream data from the advertiser's web site 606, performance targets set by the advertiser, and the current state of the auction. In the depicted embodiment, a recommendation consists of a maximum amount to bid and the bid hiding update frequency.

The bid management component of the system 600 depicted in FIG. 6 is the Bid Manager 616. As depicted, the Bid Manager 616 manages the actual bid in the auction to the recommendation in the context of the constraints and the varying state of the auction. The Bid Manager 616 updates the bid for a listing (if necessary) based on the recommended bid hiding rate. Each time a listing is considered, the recommended bid is limited by the current bids associated with the minimum position and maximum position constraints. The bid is further limited by the minimum bid and maximum bid constraints. Finally, the bid is further constrained by any limits imposed by the auction itself.

In some embodiments, the Bid Optimizer 618 produces recommendations which consist of a maximum bid and a value-based bid-hiding rate (or refresh rate). The bid hiding rate is proportional to the advertiser's spend rate on the listing.

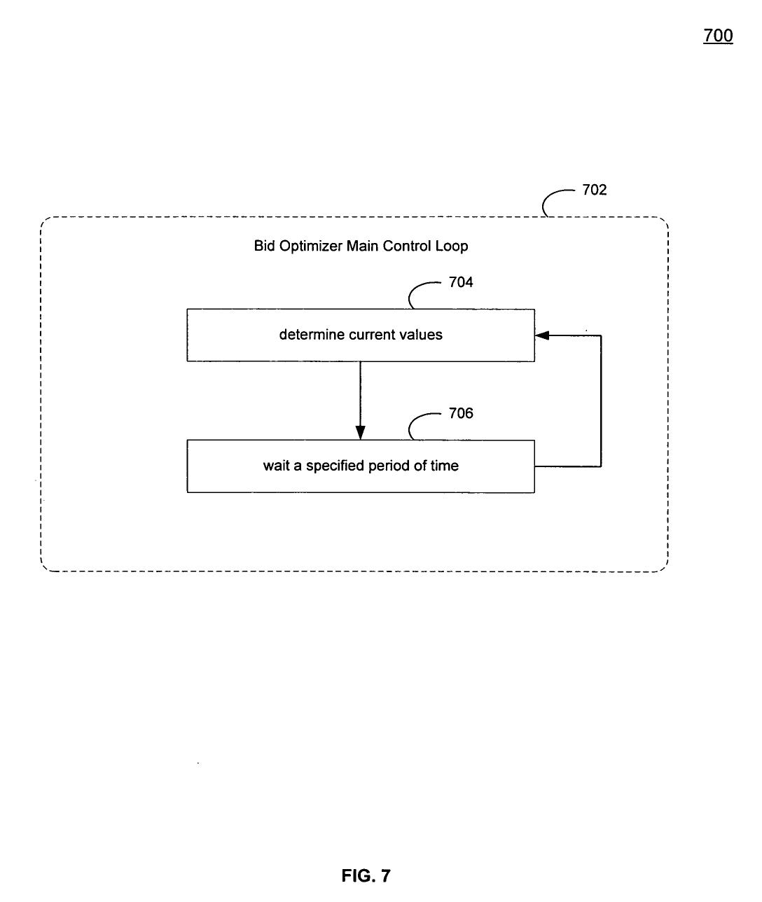

FIG. 7 is a flow diagram depicted a method 700 according to one embodiment of the invention. In some embodiments, the implementation of a Bid Optimizer is in the style of a control loop optimizer, although other implementations are contemplated. The depicted method 700 is performed by a control loop style Bid Optimizer. The depicted method 700 is a main control loop performed by some embodiments of a bid optimizer. As depicted, at step 702, the bid optimizer determines current recommended values, including a recommended maximum bid and bid hiding rate (or refresh rate). At step 704, the bid optimizer waits a specified period of time to allow current recommended and utilized values to have sufficient effect. After waiting the specified period of time at step 706, the method 700 returns to step 704, at which the bid optimizer determines new current recommended values, including a new recommended maximum bid and bid hiding rate.

In some embodiments, one or more algorithms or programs are used in determining a recommended maximum bid or recommended bid hiding rate. One feature or strategy of such an algorithm according to some embodiments is use of a variable amount of recent analytics data for evaluating performance that is proportional to the “velocity” of the listing. The strategy is to look at only enough data, or wait long enough to look at only enough data, to achieve sufficient confidence (in the statistical sense), or an amount of confidence determined or decided by, for example, a marketplace operator to be sufficient, to evaluate the recent performance of the listing. For example, in some instances, if 10,000 conversions have been measured, it may not be needed to consider all 10,000 to determine the C.P.A.; the most recent 10 conversions are probably sufficient. The advantage to looking at only enough data is that it maximizes the effect of the current conditions and therefore allows better decisions to be making.

Another feature or strategy used by some embodiments of the bid optimizer is sensitivity to the type and quality of analytic data that is available for a listing. With this strategy, the more statistically significant the performance evaluation, the more aggressively the recommended bid is changed. The advantage is that a more can be more aggressive approach can be employed when more reliable data is available, and a more conservative approach can be employed when the data is less conclusive.

Another feature or strategy used by some embodiments of the bid optimizer is the following methodology for optimizing low-velocity listings. The sensitivity to the type and quality of the analytic data allows distinguishing of low-velocity listings and application of different recommendation algorithms. In particular, of concern are terms that have not had a conversion recently, so that computation of CPA or ROAS cannot be made. The strategy is to slowly bid higher until spending more than a particular threshold on that listing recently, and then slowly bid lower. For listings with a CPA target, the target is used as the spend threshold. For listings with a ROAS target, the measured CPA of the campaign containing the listing is used. If that is not available, the measured CPA for the advertiser's web site as a whole used. If that is not available, a nominal value for the threshold is used. Another option, used in some embodiments, is to allow the advertiser to configure the threshold as another control parameter. The strategy is to bid higher to try to get more traffic in hopes of getting conversions; by the time the listing bids down to the minimum bid, generally somewhat more is spent than the target CPA, so even if a conversion is obtained at that point, a lower bid would still be recommended. In other words, the more one spends beyond the CPA target without a conversion, the more confident (in the statistical sense) that the CPA target cannot be achieved for the listing.

Another feature or strategy used by some embodiments of the bid optimizer is to use a variable refresh rate that is proportional to the “velocity” of the listing. From one perspective, it is desirable to maximize the refresh rate, because it determines the convergence rate for the bid optimizer as well as the ability of the bid optimizer 508 to track high frequency changes in performance. However, if the refresh rate is too fast then the current settings will not have had a chance to have an impact on performance and the bid optimizer will tend to overshoot the optimal settings. As such, a high refresh rate can be advantageous in terms of bid optimization in that it allows better accuracy or “granularity” with respect to analyzing rapidly changing performances, and changing settings accordingly. However, if the refresh rate is too high, then insufficient time will have passed to accurately assess setting impacts.

Therefore, it is desirable is to utilize a refresh rate window that is balanced so as to be large enough to yield sufficient statistical significance in assessing setting impacts, yet small enough to respond with sufficient agility to changing performance. In some embodiments, the refresh interval is set to be 20% of the interval over which we the performance analytics are considered, or one day, whichever is shorter, which has been found to be a good overall balance in across most listings and circumstances. However, in some embodiments, the window is calculated in a more sophisticated manner to be itself optimized.

For example, it has been observed, however, that conversion rates and rate change rapidity for a particular search term or term group can vary dramatically depending on the day of the week or time of day of the associating searching (conversion rate being specifiedin this example in terms of conversions divided by leads). For example, search engine users researching new car prices may be much less likely to buy if the searching occurs late at night or on a particular day or days of the week. This can result in conversion rates and rate change frequency or rapidity that varies sharply depending on the day of the week and time of the day.

It has also been observed that buying cycles can vary sharply for different products. A buying cycle can represent the amount of time between a lead first visiting a Web site and the lead producing a conversion, such as by buying an advertised product. For example, car buyers may typically wait longer, such as a week or two, before buying a car they investigate, as opposed to, for example, buyers of books, who are likely to act right away or within a day or two. Also, peak amounts of time between lead acquisition and buying may vary for different products, services, content, etc. The buy cycle can influence or throw off association of leads with conversions, and therefore can skew conversion rates, if a refresh rate window is too small.

For reasons such as the above, in some embodiments, refresh rate is optimized or balanced based at least in part on factors including observed variances in conversion rate and rate change rapidity, particular buy cycles, or other factors. For example, a larger window may be utilized during days or times when conversion rate change rapidity is anticipated to be low or the buy cycle lengthy, and a shorter window utilized during days or times when conversion rate change rapidity is anticipated to be high. Additionally, anticipated changes in conversion rates based on day of the week or time of the day (or other factors, such as holidays, seasons, current events, etc.) can be factored into determining optimal settings.

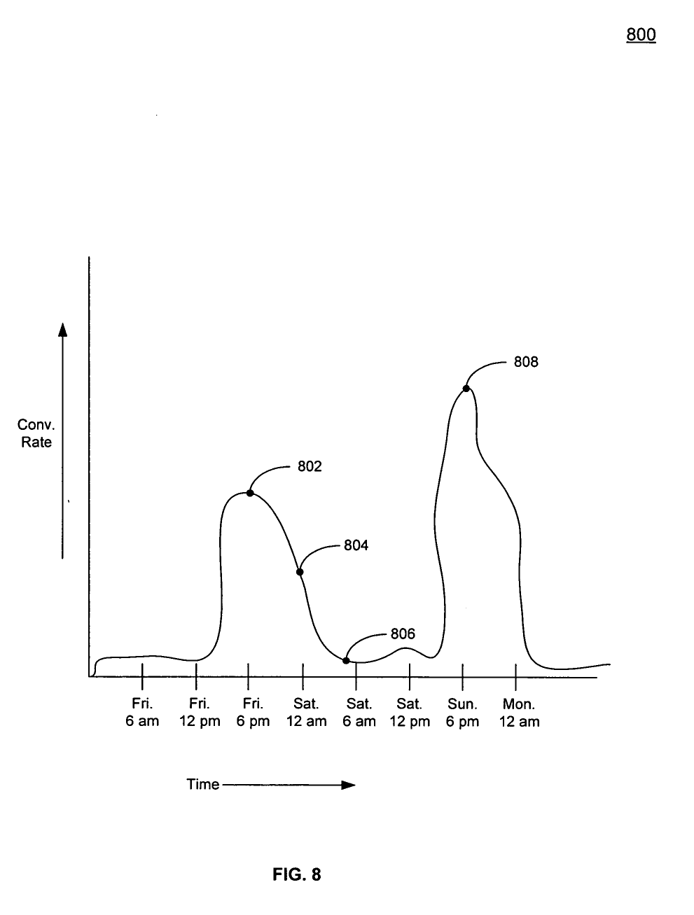

FIG. 8 is a graph of conversion rate versus time for a hypothetical search term or term group, according to one embodiment of the invention. FIG. 8 illustrates n example of how conversion rate and rate change rapidity (or rate) may vary based on the day of the week or time of day. As depicted, conversion rate peaks and remains relatively stable on Friday for a several hour period centered around about 8 pm, as depicted by data point 802. By data pint 804, at about 12 am, the conversion rate is dropping rapidly. By data point 806, at about 5 am on Saturday, the conversion rate is at a low point for Saturday, and is again relatively stable. By data point 808, at about 8 pm on Sunday, the conversion rate has peaked for Sunday, and the peak is higher than the peak on Friday. In some embodiments, the bid optimizer 508 is programmed to analyze data including information on historical and anticipated conversion rates over time, which data may be frequently updated, and factor this data into determination of settings including, for example, a maximum bid and refresh rate.

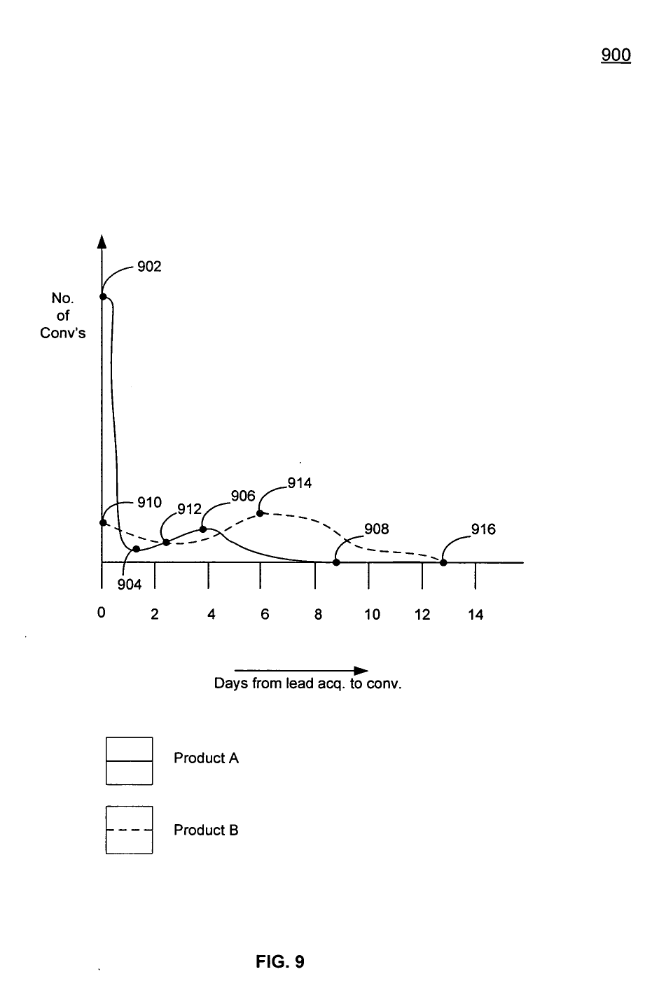

FIG. 9 is a graph 900 of hypothetical buy cycles, in terms of number of conversions versus time from lead acquisition, for each of two different products, product A (cycle depicted using a solid line) and product B (cycle depicted using a dotted line). As depicted, for product A, a high initial peak occurs immediately after lead acquisition at data point 902. This is followed by a sharp drop off to a low at data point 904 at about the end of day 1, rising slowly to a secondary, lower peak at data point 906 at about day 4, and very slowly dropping off to zero of almost zero by data point 908 at about day 9.

For product B, a lower initial peak occurs immediately following lead acquisition at data point 910, followed by an only somewhat sharp drop off to a low at data point 912 at about day 2. This is followed by a gradual rise to secondary peak at data point 914 at about day 6 followed finally by a slow decline to zero or almost zero by data point 916 at about day 13.

As FIG. 9 shows, buying cycles can vary substantially between advertised products, services, content, etc., including peaks and drop offs at different times, changes in the rate of conversion increase or decrease at different times, and drop off to zero or almost zero at different times. In some embodiments, this information, which can include statistics, curves, and models based on historical buy cycle information for various types of products, as well as frequent updates, can be provided to the bid optimizer 508, which determines settings based at least in part on the information. For example, a larger refresh window may be determined for longer buy cycles to ensure leads are accurately associated with associated conversions.

FIG. 10 is a simplified screen shot 1000 according to one embodiment of the invention. In some embodiments, Marketing Console 1002 includes a user-interactive interface provided by a Web application or set of applications, accessible via the Internet, made available to advertisers (or other entities with or controlling ad campaigns, or managers of Marketing Console 1002 itself). Marketing Console 1002 can be used for a host of purposes to facilitate management and optimization of ad campaigns. Marketing Console 1002 may be accessible via the Internet, and access may be secured by various means known in the art, included password protected access.

In some embodiments, Marketing Console 1002 can be used by advertisers to facilitate ad campaign management and optimization, which can include, for example, management of listings associated with an auction-based search-term related sponsored search results listings marketplace. For example, advertisers can use Marketing Console to access ad campaign information and ad campaign performance information saved in a relational ad campaigns database, search the information, analyze the information, obtain reports, summaries, etc. Advertisers can also change listings or bidding strategies using Marketing Console 1002, which changes are updated in the ad campaigns database. Furthermore, Marketing Console 1002 can be used to perform comparisons of performance of components of ad campaigns, such as performance of particular listings, search term creatives, channels, tactics, etc.

While Marketing Console 1002 is described with reference to an auction-based search term-related sponsored listings context, it is to be understood that, in some embodiments, Marketing Console can be used with regard to off-line or non-sponsored search ad campaigns and ad campaign performance, or combinations of on-line and off-line ad campaigns information, as well.

Marketing Console 1002 takes advantage of and facilitates leverage of the wealth of ad campaign and ad campaign performance information stored in an ad campaigns database, such as the ad campaigns database 136 depicted in FIG. 1. One such tool, as depicted in FIG. 10, is Search Optimizer 1004. Generally, Search Optimizer 1004 can be used for access to ad campaign and ad campaign performance data, providing summaries, reports, and obtaining exportable spreadsheet data or files to be used outside Market Console 1002.

Users can interact with Search Optimizer 1004 to specify parameters for customized collection, searching, presenting, analyzing, and reporting of data. For instance, a user can specify a particular aspect of an ad campaign, or a particular time frame, or both, and request corresponding data or summaries. A user may, for instance, specify channel or tactic, a particular search term or creative, and a time frame, and request summary information. Search Optimizer 1004 can access and use the information in a relational ad campaigns database in responding to the user request. The ad campaigns database includes data collected from potentially many disparate sources, which can include information from many affiliates as well as information from the advertiser's Web site itself, which can be utilized by Search Optimizer 1004. Search Optimizer 1004 can also be used by advertisers to modify their ad campaign information in an ad campaigns database.

As depicted, a user can enter the parameters of a request or search in the parameters area 1006, and obtain results in the results area 1008. In the depicted example, a user has requested, and results are provided, indicating a set of search terms, or keywords, as used in the Yahoo! search engine. A chart 1012 is provided that includes a list 1008 of the keywords and rows 1010 including metrics or analytics associated with the keywords, which can be expressed in numerous ways including performance metrics such as CPAs, ROAS, etc., percentage, etc. For example, a user may obtain results allowing comparison of performance between different affiliates, different creatives, etc. Of course, a great variety of information, and ways to organize it, are possible and available to users.

Using marketing console 1002 thereby provides advertisers with convenient and easy way to access customized reports or analyses on campaign information, with the advantage of the availability of a great collection of data from a variety of disparate sources.

As depicted, any of a series of tool groups 1014 are selectable by users. As depicted, the configuration management tool group is selected. It is to be kept in mind that the screen shot 1000 is simplified to exclude display of details which can include subgroups of tools and other features.

In some embodiments, users can use Search Optimizer to specify and user “watch lists”. Watch lists can include information on particular selected items, such as tracked performance of the most important search terms of the advertiser, allowing easy and immediate access to critical data.

In some embodiments, Search Optimizer can be used to select an “auto-accept mode” in which a user specifies that recommendations of a bid optimizer are to be implemented automatically, or a mode in which recommendations are presented to users for acceptance before being implemented, or a manual mode which bypasses the bid optimizer. In some embodiments, auto-accept mode can be used in some instances or for some terms, and a different mode used for others.

Information accessed through Search Optimizer 1004 can include an indication of settings such as bid settings and refresh rates, and can provide an indication of which settings have been implemented or last changed automatically and which have been implemented or last changed manually.

Marketing Console 1002 can also provide access to billing and pricing information in connection with the marketplace operator.

In some embodiments, Marketing Console can also be used by managers or agents of the marketplace operator. Such users can use Marketing Console for such purposes as tracking (and displaying reporting, etc.) usage of Marketing Console by other users, tracking usage of server computers of the marketplace operator, troubleshooting software or hardware problems, etc.

1. A system for providing an interactive advertiser interface to facilitate managing one or more ad campaigns, the apparatus comprising:
one or more ad campaigns facilitation servers, of an ad campaign facilitator, connected to a network;
one or more ad campaigns databases connected to the one or more ad campaigns facilitation servers;
a plurality of affiliates, of the ad campaign facilitator, connected to the network; and
a plurality of advertisers connected to the network;
wherein the one or more ad campaigns facilitation servers are adapted to obtain ad campaign information, relating to the ad campaigns, from one or more advertisers;
wherein the one or more ad campaigns facilitation servers are adapted to obtain ad campaign performance information, relating to the ad campaigns, from the advertisers and the affiliates;
wherein the one or more ad campaigns facilitation servers are adapted to store the ad campaign information and the ad campaign performance information in the one or more ad campaigns databases;
and wherein the one or more campaigns facilitation servers are adapted to provide one or more user-interactive applications to allow advertisers access to and manipulation of ad campaign and ad campaign performance information, in order to facilitate managing the ad campaigns.

2. The system of claim 1, wherein the one or more ad campaigns facilitation servers are adapted to facilitate implementing bidding strategies for advertisers in an auction-based search term-related sponsored listings marketplace.

3. The system of claim 1, wherein the one or more ad campaigns facilitation servers are adapted to facilitate implementing bids relating to search term creatives.

4. The system of claim 3, wherein the one or more ad campaign facilitation servers are adapted to utilize a maximum bid hiding strategy in implementing bids.

5. The system of claim 4, wherein the one or more ad campaigns facilitation servers are adapted to automatically implement bidding strategies for advertisers.

6. The system of claim 5, wherein the one or more ad campaigns facilitation servers are adapted to utilize information stored in the ad campaigns database to determine optimal bidding strategies for advertisers.

7. The system of claim 6, wherein the one or more ad campaigns facilitation servers are adapted to automatically implement the determined optimal bidding strategies.

8. The system of claim 1, wherein providing the user-interactive interface comprises providing advertisers with an ability to search, obtain analyses of, and obtain summary information regarding ad campaign information and ad campaign performance information.

9. The system of claim 8, wherein providing the user-interactive interface comprises providing advertisers with watch lists of information relating to advertiser-selected search-term creatives.

10. The system of claim 1, wherein obtaining ad campaign performance information from each of a plurality of affiliates comprises obtaining ad campaign performance information from each of a plurality of disparate affiliates.

11. The system of claim 10, wherein obtaining ad campaign performance information from each of a plurality of disparate affiliates comprises obtaining ad campaign performance information from at least one on-line affiliate and at least one off-line affiliate.

12. The system of claim 1, wherein obtaining ad campaign performance information from one or more advertisers comprises obtaining ad campaign performance information from a plurality of disparate advertisers.

13. The system of claim 1, comprising storing the ad campaign information and the ad campaign performance information in the ad campaigns database in an integrated manner.

14. The system of claim 1, wherein at least one of the affiliates interface with the one or more ad campaigns facilitation servers using one or more application program interfaces.

15. The system of claim 1, wherein the one or more ad campaigns facilitation servers comprise a plurality of geographically distributed ad campaigns facilitation servers, and comprising replicating changes to ad campaign information and ad campaign performance information through several of the ad campaigns facilitation servers to facilitate information synchronization.

16. The system of claim 1, wherein the one or more ad campaigns facilitation servers are of a marketplace operator, and wherein the marketplace operator operates an auction-based search term-related sponsored listings marketplace for participation by advertisers.

17. The system of claim 16, comprising utilizing an offer exchange engine to facilitate providing the marketplace.

18. The system of claim 1, wherein the one or more ad campaigns facilitation servers are adapted to facilitate instrumentation of advertiser Web sites with HTML tags to facilitate automated collection of ad campaign performance information to be obtained by the one or more ad campaigns facilitation servers and stored in the one or more ad campaigns databases.

19. An apparatus for providing an interactive advertiser interface to facilitate managing one or more ad campaigns, the apparatus comprising:
one or more ad campaigns facilitation servers, of an ad campaign facilitator, connected to a network;
one or more ad campaigns databases connected to the one or more ad campaigns facilitation servers;
a plurality of affiliates, of the ad campaign facilitator, connected to the network; and
a plurality of advertisers connected to the network;
wherein the one or more ad campaigns facilitation servers are adapted to obtain ad campaign information, relating to the ad campaigns, from one or more advertisers;
wherein the one or more ad campaigns facilitation servers are adapted to obtain ad campaign performance information, relating to the ad campaigns, from the advertisers and the affiliates;
wherein the one or more ad campaigns facilitation servers are adapted to store the ad campaign information and the ad campaign performance information in the one or more ad campaigns databases;
and wherein the one or more campaigns facilitation servers are adapted to provide one or more user-interactive applications to allow advertisers access to and manipulation of ad campaign and ad campaign performance information, in order to facilitate managing the ad campaigns.
